(19) United States
(12) Patent Application Publication
(10) Pub. No.: US 2011/0122740 A1
(43) Pub. Date: May 26, 2011

(54) SIMPLE RESUME REPRODUCTION DEVICE AND SIMPLE RESUME REPRODUCTION METHOD

(75) Inventors: Yoshio KAWAKAMI, Osaka (JP); Satoshi OGATA, Kanagawa (JP)

(73) Assignee: PANASONIC CORPORATION, Osaka (JP)

(21) Appl. No.: 13/012,134

(22) Filed: Jan. 24, 2011

Related U.S. Application Data
(63) Continuation of application No. PCT/JP2009/001601, filed on Apr. 7, 2009.

(30) Foreign Application Priority Data
Jul. 25, 2008 (JP) 2008-192108

(51) Int. Cl. G11B 7/085

(52) U.S. Cl. 369/30.04; G9B/7.042

(57) ABSTRACT

A simple resume reproduction device which performs resume reproduction after reproduction of content is interrupted. Content; an application that is a program for reproducing the content; and at least one reproduction control information item for controlling execution of the application are recorded on a recording medium. The simple resume reproduction device includes: a reproduction unit which reproduces the content by executing the application controlled according to a first reproduction control information item; and a reproduction information acquiring unit which acquires reproduction information indicating a reproduction position of the content. Further, the reproduction unit, when resuming reproduction, reproduces the content from the reproduction position indicated by the reproduction information without executing the application.

### CROSS REFERENCE TO RELATED APPLICATION

This is a continuation application of PCT application No. PCT/JP2009/001601 filed on Apr. 7, 2009, designating the United States of America.

### BACKGROUND OF THE INVENTION

(1) Field of the Invention

The present invention relates to a simple resume reproduction device and simple resume reproduction method for performing resume reproduction by which, when reproduction of content is interrupted for some reason during the reproduction, the next reproduction starts from the point where the reproduction is interrupted in the previous reproduction.

(2) Description of the Related Art

In reproduction of data such as images or audio recorded on a recording medium represented by a digital versatile disc (DVD), the reproduction can be interrupted in some cases when, for example, a stop key is pressed, a power-off operation is carried out, or power is suddenly shut off.

In conventional techniques such as the one described in Patent Reference 1 (Japanese Unexamined Patent Application Publication No. 2003-77222), reproduction can be resumed at the position where the reproduction is previously interrupted, by storing reproduction information that indicates a physical or logical reproduction position and the like when the reproduction is interrupted. In addition, executing instructions included in content and used in a menu display and the like can also be resumed in the next reproduction, by storing information on the position to which execution has been carried out and a memory region used by the instructions. These are operations generally called resume reproduction.

Content specified by the blu-ray disc read only memory (BD-ROM) standard can include plural titles. The title indicates a unit of reproduction of content, and conventional reproduction devices reproduce content indicated by the unit of reproduction.

The titles are roughly classified into two types. One is a high definition movie (HDMV) title having a mechanism similar to the DVD. The other is a blu-ray disc Java (BD-J) title. Data such as images and audio is the same as that of the HDMV title. However, with the BD-J title, display of a menu and control on reproducing images and audio are carried out with a Java™ application described in a Java language. It is possible, with the Java application, to perform processing with a high degree of freedom which is not present in instructions of the DVD and the like. Such processing with a high degree of freedom includes controlling plural threads, controlling a vast variable region, and rendering on screen with a high degree of freedom.

Reproduction can also be interrupted due to the above-described reasons during reproduction of content indicated by the titles of these two types. It is desired that the resume reproduction can be carried out in this case as well.

For example, with the HDMV title, the resume reproduction can be carried out using conventional techniques such as Patent Reference 1 since the mechanism is similar to the DVD.

With the above-described conventional technique, however, there is a problem that the operation of the Java application included in the BD-J title cannot be restored to the state at the point of interruption. That means that there is a problem that content cannot be reproduced from the position where reproduction is interrupted.

In the case of the instructions used in a DVD and the like, reproduction can be resumed by only storing, in a memory, what number of instruction is executed and a storage region available to the instructions. In the case of the Java application, however, processing such as controlling plural threads, controlling a vast range of a variable, and rendering on screen with a high degree of freedom is carried out in an operation system different from the execution of instructions of a DVD and the like. In addition, since reproduction cannot be resumed at a stop position using only conventional techniques due to the tremendous increase in instruction complexity, resume reproduction of the BD-J title cannot be carried out.

Here, when the Java application is operated on a personal computer, it is possible to interrupt the execution using general techniques called suspend or hibernation and resume the execution afterwards. However, in such a case as power supply is cut after the Java application is interrupted, in particular, it is necessary to store memory information used for the operation of the Java application and management information held by the operating system (OS), in order to resume the operation of the Java application, and the information needs to be stored in a nonvolatile storage region that is not affected by the availability of a power supply. The information is generally stored in a hard disk or a nonvolatile memory in most cases.

However, consumer electronics (CE) such as household appliances and on-vehicle players often lack sufficient hardware resources necessary for hibernation, compared to personal computers (PC). More specifically, there are many cases where the information to be stored at the time of interruption cannot entirely be stored in the nonvolatile storage region.

The present invention solves the above-described conventional problems, and it is an object thereof to provide a simple resume reproduction device and a simple resume reproduction method which enable resume reproduction of a title including the Java application in the BD-ROM.

### SUMMARY OF THE INVENTION

In order to solve the above-described conventional problems, the simple resume reproduction device according to an aspect of the present invention is a simple resume reproduction device which performs resume reproduction after reproduction of content recorded on a recording medium is interrupted, wherein, the following are recorded on the recording medium: the content; a first application that is a program for reproducing the content; and at least one first reproduction control information item for controlling execution of the first application, the simple resume reproduction device comprising: a reproduction unit configured to reproduce the content by executing the first application controlled according to the at least one first reproduction control information item; and a reproduction information acquiring unit configured to acquire reproduction information indicating a reproduction position of the content, wherein the reproduction unit is further configured to perform simple resume reproduction without executing the first application when performing the resume reproduction, the simple resume reproduction being processing in which the content is reproduced from the reproduction position indicated by the reproduction information acquired by the reproduction information acquiring unit.

With this, even when reproduction is interrupted while the content is reproduced by executing an application recorded on a recording medium, it is possible to reproduce the content from a reproduction position based on the reproduction information indicating the reproduction position and so on. Thus, since the application is not executed in the simple resume reproduction, the content can be reproduced even when information cannot entirely be stored in the nonvolatile storage region due to an insufficient capacity of the nonvolatile storage region, a configuration incapable of sufficiently securing the power supply, and so on.

In addition, the simple resume reproduction device may further include a data generating unit configured to generate first data for enabling reproduction from the reproduction position indicated by the reproduction information, based on the reproduction information acquired by the reproduction information acquiring unit, and the reproduction unit may be configured to perform, when performing the resume reproduction, the simple resume reproduction by referring to the first data generated by the data generating unit.

With this, it is possible to significantly reduce the necessary memory region by including, into data generated based on the reproduction information, information that enables reproduction from the reproduction position and reproducing the content based on the generated data, compared to the case of performing the resume reproduction by storing, into the memory, the application before interruption as it is. Therefore, the resume reproduction can be performed not only by PCs but also by a device having a small memory size, such as household appliances, on-vehicle players, and the like.

In addition, the simple resume reproduction device may further include: a nonvolatile storage unit; and a reproduction information storage unit configured to store, in the nonvolatile storage unit, the reproduction information indicating the reproduction position at which the content is being reproduced or the reproduction of the content is interrupted, and the reproduction information acquiring unit may be configured to acquire, when performing the resume reproduction, the reproduction information stored in the nonvolatile storage unit, and the data generating unit is configured to generate the first data when performing the resume reproduction.

With this, since it is sufficient to store the reproduction information while the content is reproduced or when the reproduction is interrupted, the resume reproduction can be performed even by a device having a small memory size.

In addition, the simple resume reproduction device may further include a determination unit configured to determine whether or not to perform the simple resume reproduction, and the reproduction unit is configured to perform, when performing the resume reproduction, the simple resume reproduction only when the determination unit determines that the simple resume reproduction is to be performed.

With this, it is possible to perform the processing in which the simple resume reproduction is not executed. When reproduction of content is interrupted just after the reproduction is started (within a minute, for example), for example, it is desirable to start the content from the beginning in a normal reproduction.

In addition, the reproduction information storage unit may be configured to store the reproduction information into the nonvolatile storage unit only when the determination unit determines that the simple resume reproduction is to be performed, and the reproduction unit may be configured to perform the simple resume reproduction only when the reproduction information is stored in said nonvolatile storage unit.

With this, it is possible to avoid storing the reproduction information when the simple resume reproduction is not performed. Therefore, it is possible to effectively use the nonvolatile memory.

In addition, the simple resume reproduction device may further include a nonvolatile storage unit, the data generating unit may further be configured to store the generated first data into the nonvolatile storage unit, and the reproduction unit may be configured to reproduce the content from the reproduction position, as the simple resume reproduction, by referring to the first data stored in the nonvolatile storage unit.

With this, it is possible, while the content is reproduced, to generate data necessary for the resume reproduction making it possible to start the resume reproduction earlier.

In addition, the data generating unit may be configured to generate the first data including second reproduction control information of a type different from a type of the at least one first reproduction control information item, and the reproduction unit may be configured to reproduce the content from the reproduction position, as the simple resume reproduction, the content being referred to from the second reproduction control information included in the first data generated by the data generating unit.

With this, it is possible to perform the simple resume reproduction in a mode different from a mode of the unit of reproduction recorded on the recording medium. Therefore, reproduction can be carried out without using the application.

In addition, the data generating unit may be configured to generate, as the first data, data including a command for reproducing the content from the reproduction position, the content being referred to from the second reproduction control information, and the reproduction unit may be configured to reproduce the content according to the command from the reproduction position, as the simple resume reproduction, the content being referred to from the second reproduction control information included in the first data.

With this, although the processing exactly the same as that before interruption cannot be performed, it is possible to reproduce the images and audio from the position where the reproduction is interrupted, by changing the mode into the HDMV mode and reproducing the content, even when the content is reproduced by executing the Java application or the like before the interruption, for example.

In addition, the data generating unit may further be configured to generate second data in advance, the second data specifying the second reproduction control information, the nonvolatile storage unit may be configured to store the second data, and the data generating unit may be configured to generate, as the first data, data including a command for reproducing the content from the reproduction position, based on the reproduction information acquired by the reproduction information acquiring unit, the content being referred to from the second reproduction control information specified by the second data.

This eliminates the necessity of including reproduction control information into the reproduction information because the unit of reproduction (title) that is the reproduction control information can be determined in advance. Thus, since it is possible to generate only the data necessary for the resume reproduction, time taken for generating the data can be reduced. In addition, time taken for reading the data can also be reduced.

In addition, the data generating unit may be configured to generate the first data including second reproduction control information that controls execution of a second application different from the first application controlled by the at least one first reproduction control information item, and the reproduction unit may be configured to reproduce the content from the reproduction position, as the simple resume reproduction, by executing the second application controlled by the second reproduction control information included in the first data generated by the data generating unit.

With this, it is possible to perform the simple resume reproduction by executing an application different from an application recorded on the recording medium. More specifically, whereas the resume reproduction cannot be performed conventionally because the application recorded on the recording medium is to be used, it is possible to perform the resume reproduction with the simple resume reproduction device according to the present invention because the application generated by the simple resume reproduction device is used.

In addition, the simple resume reproduction device may further include an accepting unit configured to accept an instruction from a user, and the reproduction unit may be configured to reproduce the content based on the instruction accepted by said accepting unit.

For example, the accepting unit may be configured to accept the instruction indicating whether or not to perform the simple resume reproduction, and the reproduction unit may be configured to execute the simple resume reproduction when the instruction accepted by the accepting unit indicates that the simple resume reproduction is to be performed.

With this, it is possible, in the processing related to the simple resume reproduction, to determine changing the processing based on the result of determination by the user.

In addition, the accepting unit may be configured to accept, during the simple resume reproduction, the instruction indicating whether normal reproduction different from the resume reproduction is to be performed or the simple resume reproduction is to be continued, and the reproduction unit may be configured to perform the normal reproduction or the simple resume reproduction, based on the instruction accepted by the accepting unit.

With this, the user can determine whether to perform reproduction in a reproduction system as intended by the content in the recording medium or to continue the simple resume reproduction.

In addition, the simple resume reproduction device may further include: an instruction executability determining unit configured to determine whether or not the instruction accepted by the accepting unit is executable; and an informing unit configured to inform the user that the instruction is not executable when the instruction executability determining unit determines that the instruction is not executable.

With this, it is possible to determine whether or not a user operation is accepted in the simple resume reproduction.

In addition, the simple resume reproduction device may further include an informing unit configured to inform the user that the reproduction performed by the reproduction unit is the simple resume reproduction or normal reproduction.

With this, it is possible to easily determine whether or not the images and audio currently being reproduced is reproduced in the simple resume reproduction.

In addition, the simple resume reproduction device may further include an informing unit configured to inform the user that the reproduction performed by the reproduction unit is the simple resume reproduction or normal reproduction.

With this, it is possible to prevent discontinuity of images and audio even when reproduction of the images and audio in the simple resume reproduction is complete.

In addition, the reproduction information acquiring unit may be configured to acquire, as the reproduction information, reproduction information in compliance with a BD-ROM standard.

With this, it is possible to perform the simple resume reproduction in reproduction of the recording medium compliant with the BD-ROM standard.

In addition, the simple resume reproduction device according to another aspect of the present invention may be a simple resume reproduction device which performs resume reproduction after reproduction of content recorded on a recording medium is interrupted, wherein, the following are recorded on the recording medium: the content; an application that is a program for reproducing the content; and at least one reproduction control information item for controlling execution of the application, and the content includes a first image and a second image that is reproduced only by executing the application, the simple resume reproduction device comprising: a reproduction unit configured to reproduce the content by executing the application controlled according to the at least one reproduction control information item; and a display unit configured to display the first and second image included in the content reproduced by the reproduction unit, wherein the display unit is configured to display only the first image when resuming reproduction after reproduction of the content is interrupted.

It is to be noted that the present invention can be implemented, in addition to implementation as the simple resume reproduction device, as a method including processing units, as steps, included in the simple resume reproduction device. In addition, the present invention may be implemented as a program which, when loaded into a computer, allows a computer to execute the steps. Furthermore, the present invention may be implemented as a computer-readable recording medium having the program recorded thereon, such as a compact disc ROM (CD-ROM) and the like, and as information, data and a signal which represent the program. Furthermore, the program, the information, the data and the signal may be distributed via a communication network such as the Internet.

According to the present invention, even when reproduction of images and audio is interrupted at a given position in reproducing a title referring to a Java application in a BD-ROM, it is possible to perform, when resuming the reproduction, the resume reproduction of the images and audio from a position where the reproduction is interrupted.

### FURTHER INFORMATION ABOUT TECHNICAL BACKGROUND TO THIS APPLICATION

The disclosure of Japanese Patent Application No. 2008-192108 filed on Jul. 25, 2008 including specification, drawings and claims is incorporated herein by reference in its entirety.

The disclosure of PCT application No. PCT/JP2009/001601 filed on Apr. 7, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram which shows a home theater system that is an example of usage of a simple resume reproduction device according to Embodiment 1;

FIG. 2 is a diagram which shows a configuration of a BD-ROM according to Embodiment 1;

FIG. 3 is a diagram which shows a layer model of reproduction control according to Embodiment 1;

FIG. 4A is a diagram which shows a scene from a movie created by defining dynamic reproduction control in an HDMV mode;

FIG. 4B is a diagram which shows a scene from a movie created by defining dynamic reproduction control in a BD-J mode;

FIG. 5 is a block diagram which shows a configuration of the simple resume reproduction device according to Embodiment 1;

FIG. 6 is a block diagram which roughly shows a functional configuration of the reproduction device according to Embodiment 1;

FIG. 7 is a flow chart which shows an operation of storing reproduction information performed by a reproduction device according to Embodiment 1;

FIG. 8 is a flow chart which shows an operation of resume reproduction performed by the reproduction device according to Embodiment 1;

FIG. 9 is a flow chart which shows an operation of the simple resume reproduction performed by the reproduction device according to Embodiment 1;

FIG. 10 is a diagram which schematically shows an example of the content of index.bdmv according to Embodiment 1;

FIG. 11 is a diagram which schematically shows an example of the content of reproduction information according to Embodiment 1;

FIG. 12 is a diagram which schematically shows an example of data created by a virtual file system 423 according to Embodiment 1;

FIG. 13 is a diagram which schematically shows an example of data created by the virtual file system 423 according to Embodiment 1;

FIG. 14 is a diagram which schematically shows an example of data created by the virtual file system 423 according to Embodiment 2;

FIG. 15 is a diagram which schematically shows an example of data prepared in advance by the virtual file system 423 according to Embodiment 3;

FIG. 16 is a block diagram which shows a configuration of a simple resume reproduction device according to Embodiment 4;

FIG. 17 is a block diagram which shows a configuration of a simple resume reproduction device according to Embodiment 5;

FIG. 18 is a diagram which shows an example of a displayed image of a display 103 according to Embodiment 5;

FIG. 19 is a diagram which shows an example of a displayed image of the display 103 according to Embodiment 5;

FIG. 20 is a diagram which shows an example of a displayed image of the display 103 according to Embodiment 5;

FIG. 21 is a diagram which shows an example of a displayed image of the display 103 according to Embodiment 5;

FIG. 22 is a diagram which shows an example of a displayed image of the display 103 according to Embodiment 5; and

FIG. 23 is a diagram which shows an example of an on-vehicle digital television including the simple resume reproduction device according to an aspect of the present invention.

### DESCRIPTION OF THE PREFERRED EMBODIMENTS

Embodiments according to the present invention will be described below with reference to the drawings.

### Embodiment 1

A simple resume reproduction device according to the present embodiment, when resuming reproduction after reproduction of content is interrupted or stopped, reproduces the content from a reproduction position. Here, the reproduction position is a stop position at which reproduction is previously interrupted or stopped, or a storage position of reproduction information in the vicinity of the stop position. In the present embodiment, the storage position is also simply referred to as a stop position. It is described as “resume reproduction” as described above that reproduction is carried out from the reproduction position when starting the reproduction. In addition, it is described as “normal resume reproduction”, in particular, that resume reproduction in the HDMV mode is carried out using a conventionally known technique.

First, an embodiment of usage of the simple resume reproduction device according to the present embodiment is described.

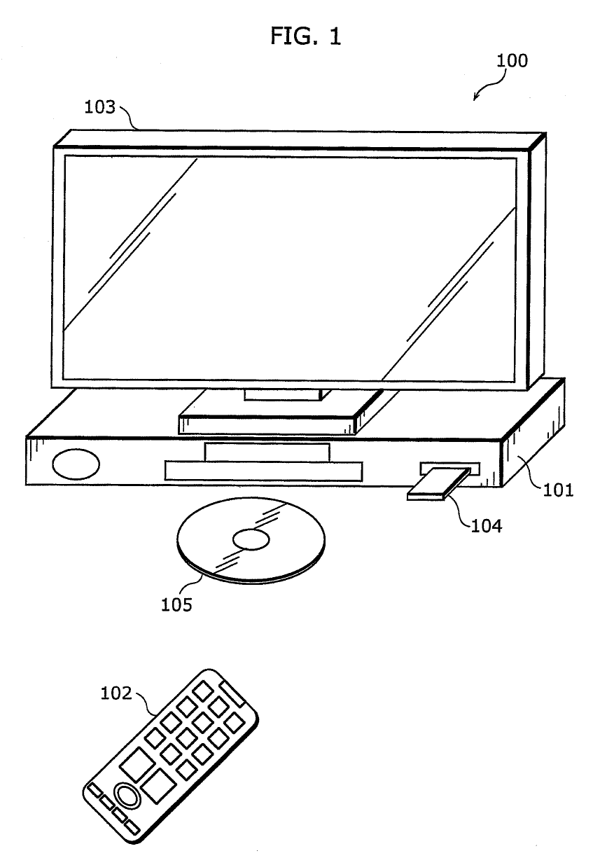

FIG. 1 is a diagram which shows a home theater system that is an example of an embodiment of usage of the simple resume reproduction device according to the present embodiment. A home theater system 100 in the diagram includes: a reproduction device 101; a remote controller 102; a display 103; a removable medium 104; and a recording medium 105. The reproduction device 101 corresponds to the simple resume reproduction device according to the present embodiment. It is to be noted that the display 103 may be a part of the simple resume reproduction device according to the present embodiment.

The reproduction device 101 is provided to be used for supplying a movie to the home theater system. The reproduction device 101 acquires content such as a movie, from the removable medium 104, the recording medium 105, the Internet, or the like, for example. Then, the reproduction device 101 displays an image on the display 103 and outputs audio from a speaker or the like (not illustrated), according to an instruction from the remote controller 102 or the like. In addition, the reproduction device 101 includes: a receiving unit that receives a signal from the remote controller 102; an insertion opening into which the removable medium 104 is inserted; an insertion opening into which the recording medium 105 is inserted; and so on.

The remote controller 102 includes various buttons and the like, and transmits an instruction from a user to the reproduction device 101, the display 103, and so on.

The display 103 displays an image processed in the reproduction device 101. In addition, the display 103 includes a speaker (not illustrated) and outputs, from the speaker, audio processed in the reproduction device 101. It is to be noted that the speaker may be included by the reproduction device 101.

The removable medium 104 is, for example, an SD memory card, a memory stick, a Compact Flash™, a smart media, a multimedia card, or the like.

The recording medium 105 is, for example, an optical recording medium such as a BD-ROM, a BD-R (Blu-ray Disc Recordable), a BD-RE (Blu-ray Disc Rewritable), and the like. Image and audio data of content such as a movie is recorded on the recording medium 105. It is to be noted that the recording medium 105 may be a DVD-ROM, a CD-ROM, or the like.

As described above, the simple resume reproduction device according to the present embodiment is used in the home theater system and so on.

The following describes a recording medium that includes content to be reproduced by the simple resume reproduction device (reproduction device 101) according to the present embodiment. In the example shown in FIG. 1, the reproduction device 101 according to the present embodiment reproduces the content of the BD-ROM that is the recording medium 105.

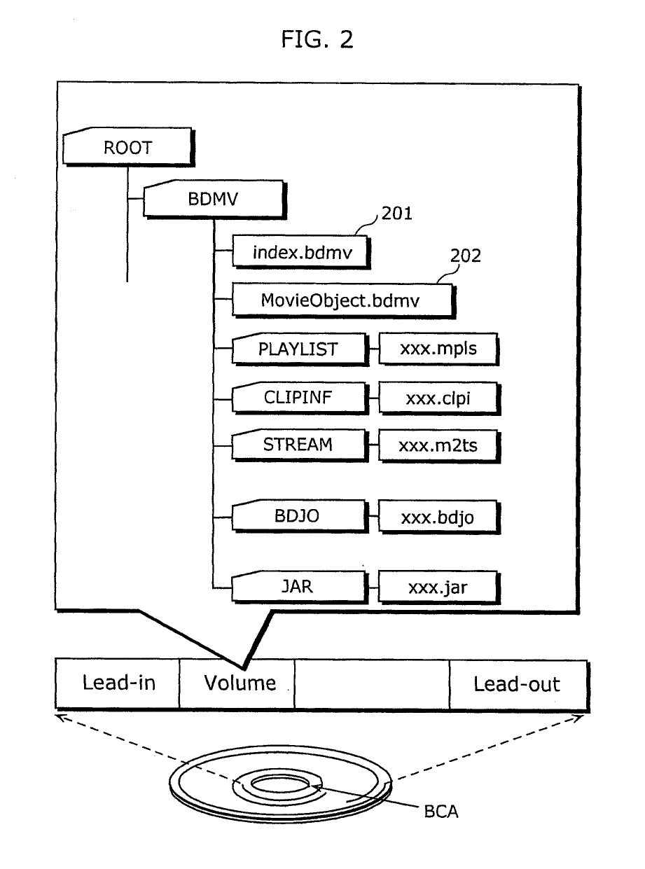

FIG. 2 is a diagram which shows a configuration the BD-ROM (hereinafter referred to also as “BD”). In the present embodiment, the BD-ROM is described focusing on an audio visual (AV) application for reproducing AV content such as a movie, however, it is also possible to use the BD-ROM as a recording medium for use in a computer, such as a CD-ROM and a DVD-ROM.

The BD-ROM includes: a storage region spirally extending from an inner circumference toward an outer circumference, just as other optical discs such as the DVD and the CD; and a logical address space in which logical data can be recorded between a lead-in on the side of the inner circumference and a lead-out on the side of the outer circumference. In addition, there is a particular region between the lead-in and the inner circumference, which can be read only by a drive and is called a burst cutting area (BCA). This region cannot be read by an application, and thus often used for a copyright protection technique, for example.

In the logical address space, file system information (volume) is recorded at the top, followed by application data such as image data. The file system is a universal disc format (UDF), ISO9660, or the like. With the file system, logical data can be read using a directory and a file structure in the same manner as a normal PC, and a file name and a directory name can be read up to 255 letters.

With the directory and the file structure on the BD disc, a BDMV directory is placed immediately under a root directory (ROOT) according to the present embodiment. The BDMV directory is a directory on which data for the BD-ROM, such AV content and management information is recorded.

There are five sub directories of a PLAYLIST directory, a CLIPINF directory, a STREAM directory, a BDJO directory, and a JAR directory, under the BDMV directory. In addition, files of two types, an index.bdmv 201 and a MovieObject.bdmv 202, are placed in the BDMV directory.

The PLAYLIST directory includes a file xxx.mpls to which an extension mpls is assigned. An identifier is assigned to “xxx” which is variable. The extension “mpls” is fixed. The CLIPINF directory includes a file xxx.clpi to which an extension clpi is assigned. An identifier is assigned to “xxx” which is variable. The extension “clpi” as is fixed. The STREAM directory is a directory in which a file that is a so-called body of a digital stream is stored, and includes a file xxx.m2ts to which an extension m2ts is assigned. An identifier is assigned to “xxx” which is variable. The extension “m2ts” is fixed. The JAR directory includes a file xxx.jar to which an extension jar is assigned. An identifier is assigned to “xxx” which is variable. The extension “jar” is fixed. The BDJO directory includes a file xxx.bdjo to which an extension bdjo is assigned. An identifier is assigned to “xxx” which is variable. The extension “bdjo” is fixed

In the file to which the extension “mpls” is assigned, playlist information is stored and a reproducing section (In Time/Out Time) of a stream is recorded.

The file to which the extension “clpi” is assigned is clip information corresponding, on a one-to-one basis, to a digital AV stream. The clip information is management information including a coding form of the digital AV stream, information on a frame rate, a bit rate, a resolution, and so on, and EP_map indicating the top position of the group of pictures (GOP).

The file to which the extension “m2ts” is assigned is a digital AV stream in the form of the moving picture experts group-transport stream (MPEG-TS), and obtained by multiplexing one or more video stream, one or more audio stream, and one or more sub image stream. The video stream indicates a video part of a movie, the audio stream indicates an audio part of a movie, and the sub image stream indicates a caption of a movie, for example.

The file to which the extension “jar” is assigned is a Java archive file on which a program of a Java application that performs a dynamic scenario control using a Java virtual machine is described. This file is necessary when reproduction of each title indicating the unit of reproduction of content on the BD-ROM is desired to be controlled by the Java application.

The file to which the extension “bdjo” is assigned is a file in which a BD-J object is stored. The BD-J object is information that defines a title by associating the application with the AV stream indicated by the PLAYLIST information. The BD-J object shows an application management table and a list of playlists that can be reproduced in the title. The application management table is a table that shows a list of the identifier of the application (application ID) and an ID of the Java archive file that belongs to the application, thereby indicating the application having the title as a living section. In other words, one application includes one or more Java archive files.

The index.bdmv 201 whose file name is fixed as “index.bdmv” is management information regarding the entire BD-ROM, and includes: information such as an organization ID (32 bits) that is an identifier specifying a provider of the movie; a disc ID (128 bits) that is an identifier assigned to each of the BD-ROMs provided by the provider; and so on. The index.bdmv 201 is first read after a disc is inserted into the reproduction device 101, thereby the disc is uniquely identified in the reproduction device 101.

In addition, the index.bdmv 201 includes a table that indicates titles that can be reproduced in the BD-ROM, the type of each of the titles, title defining information, and so on. The content of the index.bdmv 201 is collectively called mode management table. The type of a title includes a HDMV title, a BD-J title, and so on. The HDMV title is a title that operates in an HDMV mode (described later). The BD-J title is a title that operates in a BD-J mode (described later). In addition, the title defining information is an identifier that indicates which command in a command group described in the MovieObject.bdmv 202 is to be executed when the type of the title is the HDMV title. The title defining information is an identifier that indicates which BD-J object is to be used when the type of the title is the BD-J title.

The MovieObject.bdmv 202 whose file name is fixed as “MovieObject.bdmv” includes a scenario program (also referred to as a command group) in which a scenario (also referred to as a command) for dynamically changing reproduction progress in reproduction of each title in the HDMV mode.

It is to be noted that the files and directory configuration are presented as an example, and thus the present invention can be implemented with other configurations as well.

As described above, content that includes images, audio, and so on, a Java application that is a program for reproducing the content, and at least one item of reproduction control information for controlling execution of the application, that is, a BD-J title, are recorded on the recording medium 105. In addition, a command group that is a group of instructions for reproducing the content without executing an application and reproduction control information for instructing the command group, that is, a HDMV title, are recorded on the recording medium 105.

The reproduction device 101 according to the present embodiment can reproduce content: by executing an application according to the reproduction control information recorded on the recording medium 105; or in accordance with the command group indicated by the reproduction control information.

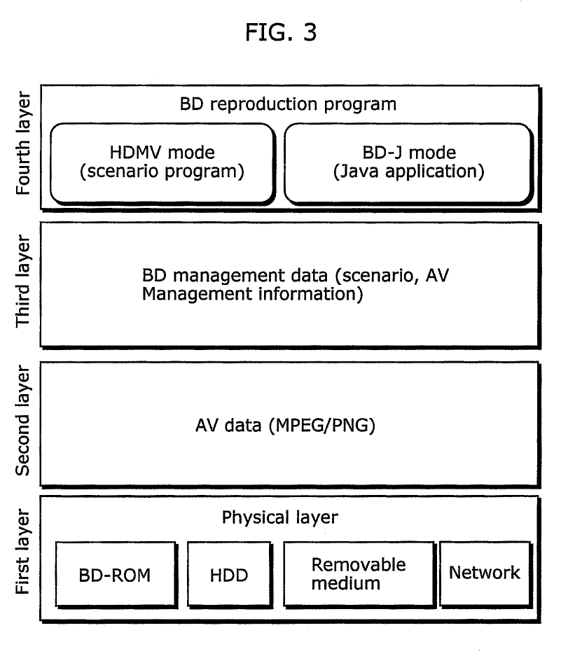

FIG. 3 is a diagram which shows a layer model of reproduction control according to the present embodiment.

The first layer in FIG. 3 is a physical layer for controlling a supply of a stream body to be processed. As shown in the first layer, the source of supply of the stream to be processed is not only the BD-ROM but also a local storage that is a recording medium such as a hard disk drive (HDD) included in advance in the reproduction device 101, a recording medium such as a removable medium, or a communication medium such as a network. The first layer performs control (a disc access, a card access, and a network communication) on the source of supply such as the local storage, the removable medium, the network, and so on, as described above.

The second layer is an AV data layer. In the second layer, what decoding system is used for decoding the stream supplied in the first layer is specified.

The third layer (BD management data) is a layer that specifies a static scenario of the stream. The static scenario is reproduction path information and stream management information specified in advance by a disc creator, and specifies a reproduction control based on the reproduction path information and the stream management information.

The fourth layer (BD reproduction program) is a layer for a dynamic scenario in the stream. The dynamic scenario is a program that executes at least one of a reproduction procedure for the AV stream and a control procedure related to the reproduction. The reproduction control by the dynamic scenario changes according to the operation on the device by a user, and have characteristics of a kind of a program.

The dynamic reproduction control here includes two modes. One of the two modes is a mode (HDMV mode) for reproducing, in a reproduction environment unique to the AV equipment, video data recorded on the BD-ROM, and the other is a mode (BD-J mode) for increasing an added value of the video data recorded on the BD-ROM. In the fourth layer, two modes of the HDMV mode and the BD-J mode are described as shown in FIG. 3. The HDMV mode is a reproduction mode in a DVD-like reproduction environment, and a scenario program in which a scenario for dynamically changing the reproduction progress is described is operated in the HDMV mode. The BD-J mode is a reproduction mode centering on a Java virtual machine, and reproduction control is carried out by the Java application.

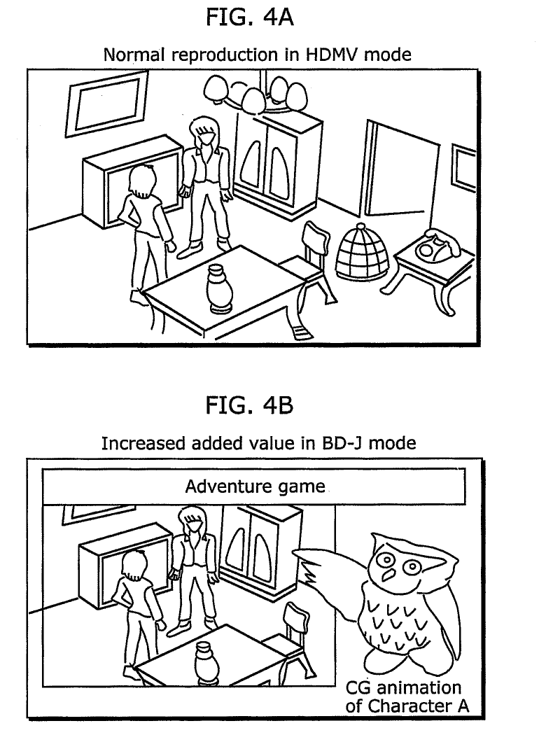

FIG. 4A and FIG. 4B are diagrams which show movies created with dynamic reproduction control in two modes. FIG. 4A is a diagram which shows a scene from a movie created by defining dynamic reproduction control in an HDMV mode. In the HDMV mode, reproduction control can be described with a command similar to a command which can be interpreted by a DVD reproduction device, and thus it is possible to define reproduction control similar to the DVD, that is, reproduction control with which selecting from menu causes reproduction to progress.

FIG. 4B is a diagram which shows a scene from a movie created by defining dynamic reproduction control in a BD-J mode. In the BD-J mode, control procedure can be described in the Java language which can be interpreted by a Java virtual machine. When motion in a computer graphics (CG) is controlled by the reproduction control, it is possible to define, in the BD-J mode, reproduction control such that CG (the image of an owl in the diagram) moves about next to a screen on which video is displayed.

The following describes a configuration of the simple resume reproduction device according to the present embodiment.

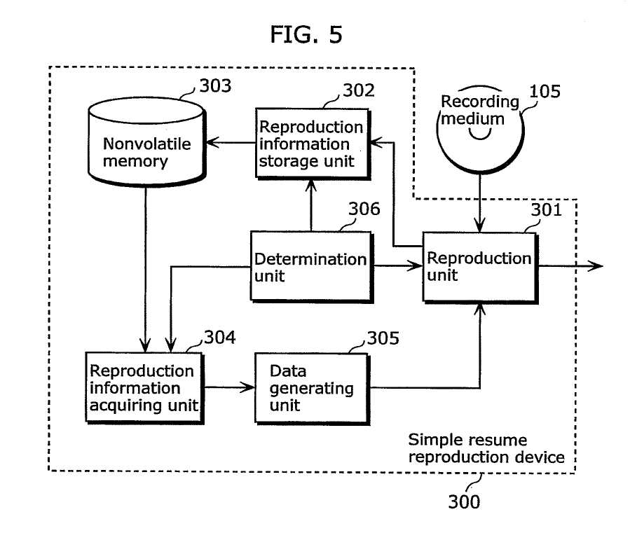

FIG. 5 is a block diagram which shows the configuration of the simple resume reproduction device according to the present embodiment. A simple resume reproduction device 300 in the diagram is a reproduction device that performs resume reproduction after reproduction of content recorded on the recording medium 105 is interrupted. The simple resume reproduction device 300 includes: a reproduction unit 301; a reproduction information storage unit 302; a nonvolatile memory 303; a reproduction information acquiring unit 304; a data generating unit 305; and a determination unit 306.

The reproduction unit 301 reproduces content by executing a Java application controlled according to at least one item of reproduction control information (BD-J title) recorded on the recording medium 105. This makes it possible to display, for example, an image as shown in FIG. 4B on the display 103.

In addition, the reproduction unit 301 executes “simple resume reproduction” when resuming reproduction after the reproduction is interrupted. With the simple resume reproduction, content is reproduced from a reproduction position acquired by the reproduction information acquiring unit 304, without executing the application that is executed before interruption. In the processing, data generated by the data generating unit 305 is referred to, thereby reproducing the content from the reproduction position.

In the present embodiment, the simple resume reproduction is, in particular, a processing that reproduces, in the HDMV mode, content that has been reproduced in the BD-J mode. More specifically, content to which is referred from the HDMV title included in generated data is reproduced from a reproduction position according to a command group included in the generated data.

The reproduction information storage unit 302 stores, into the nonvolatile memory 303, reproduction information indicating a unit of reproduction and a reproduction position at the time when the content is being reproduced or the reproduction is interrupted. For example, the reproduction information storage unit 302 stores, with a predetermined timing, reproduction information into the nonvolatile memory 303 while the content is reproduced.

The predetermined timing may be a periodic interval such as every one second, a timing of change in a reproduction state, a nonperiodic interval based on a random number or the like, or a combination of them. It is to be noted that the present invention can be implemented with whichever timing.

The nonvolatile memory 303 is a flash memory and the like in which data and the like recorded thereon is not deleted when power is shut off. Reproduction information and the like is recorded on the nonvolatile memory 303 by the reproduction information storage unit 302.

The reproduction information acquiring unit 304 acquires reproduction information and outputs the acquired reproduction information to the reproduction unit 301. The reproduction information acquiring unit 304, for example, acquires reproduction information recorded on the nonvolatile memory 303 when resuming to reproduction after the reproduction is interrupted.

The data generating unit 305 generates data, based on reproduction information, for enabling reproduction from a reproduction position indicated by the reproduction information acquired by the reproduction information acquiring unit 304. The data generating unit 305, for example, when the reproduction information acquired by the reproduction information acquiring unit 304 indicates the BD-J title, generates data including a title different from the BD-J title (the HDMV title, for example). At this time, data including a command group for reproducing, from the reproduction position, content to which is referred from the HDMV title included in the generated data is also generated so that the content is reproduced in the HDMV mode.

Details about the data to be generated will be described later. In addition, the data generating unit 305 generates data when executing resume reproduction, that is, when resuming reproduction after the reproduction is interrupted.

The determination unit 306 determines whether or not to perform the simple resume reproduction. The result of the determination is outputted to at least one of the reproduction unit 301, the reproduction information storage unit 302, and the reproduction information acquiring unit 304. The determination unit 306, for example, determines whether or not to perform the simple resume reproduction, according to an instruction from a user. Or, the determination unit 306 may determine not to perform the simple resume reproduction when a stop position is close to a start position of content, that is, when the stop position is within a predetermined period from the start position of the content (within one minute after the start, for example). In addition, the determination unit 306 may determine not to perform the simple resume reproduction when a previous interruption occurred due to an instruction from a user.

Here, it is assumed that the determination unit 306 outputs the result of determination to the reproduction unit 301. The reproduction unit 301 executes the simple resume reproduction only when the determination unit 306 determines that the simple resume reproduction should be performed.

When the determination unit 306 outputs the result of determination to the reproduction information storage unit 302, the reproduction information storage unit 302 stores reproduction information to the nonvolatile memory 303 only when the determination unit 306 determines that the simple resume reproduction should be performed. Here, when the reproduction information is not stored in the nonvolatile memory 303, the reproduction unit 301 cannot perform the simple resume reproduction, and thus performs the normal reproduction.

When the determination unit 306 outputs the result of determination to the reproduction information acquiring unit 304, the reproduction information acquiring unit 304 acquires, and outputs to the reproduction unit 301, the reproduction information from the nonvolatile memory 303 only when the determination unit 306 determines that the simple resume reproduction should be performed. Here, when the reproduction information is not inputted, the reproduction unit 301 cannot perform the simple resume reproduction, and thus performs the normal reproduction.

With the configuration described above, the simple resume reproduction device 300 generates data based on reproduction information and reproduces content to which is referred from the generated data, from a reproduction position where reproduction of the content is interrupted or where the data is generated, thereby enabling the resume reproduction. More specifically, with conventional reproduction devices, when reproduction of content in the BD-J mode is interrupted, the reproduction cannot be resumed due to complexity of the BD-J mode, whereas, with the simple resume reproduction device 300 according to the present embodiment, it is possible to execute the resume reproduction by changing the mode for reproduction to the HDMV mode.

It is to be noted that the determination unit 306 is not necessarily included in the simple resume reproduction device 300. The following describes the reproduction device 101 that corresponds to the simple resume reproduction device 300 according to the present embodiment.

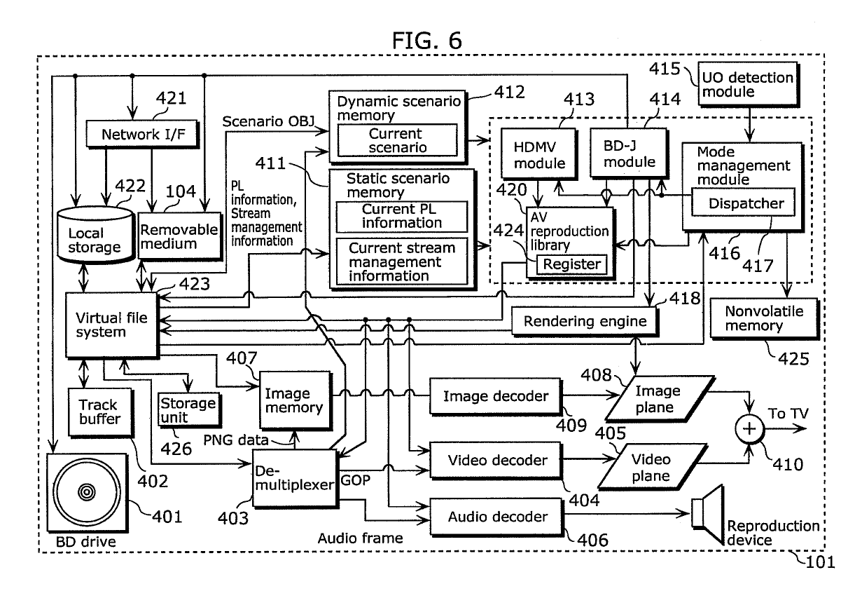

FIG. 6 is a block diagram which roughly shows a functional configuration of the reproduction device according to the present embodiment. The reproduction device 101 in the diagram includes: a BD-ROM drive 401; a track buffer 402; a demultiplexer 403; a video decoder 404; a video plane 405; an audio decoder 406; an image memory 407; an image plane 408; an image decoder 409; an adder 410; a static scenario memory 411; a dynamic scenario memory 412; an HDMV module 413; a BD-J module 414; a user operation (UO) detection module 415; a mode management module 416; a dispatcher 417; a rendering engine 418; an AV reproduction library 420; a network interface 421; a local storage 422; a virtual file system 423; a register 424; a nonvolatile memory 425; and a storage unit 426.

The BD-ROM drive 401 performs loading/ejection for the BD-ROM (an example of the recording medium 105) to execute an access to the BD-ROM. It is to be noted that the BD-ROM drive 401 may be capable of reading and writing on a readable and writable BD-RE in addition to the BD-ROM, and may further be capable of using recording media of a variety of kinds such as a DVD or a CD.

The track buffer 402 is a first in first out (FIFO) memory. In the track buffer 402, an access unit read from the BD-ROM is stored in a manner of first-in first-out system.

The demultiplexer 403 performs multiple separation on a transport stream stored on the BD-ROM loaded on the BD-ROM drive 401, the local storage 422, or the removable medium 104. Then, the demultiplexer 403 obtains a video frame, an audio frame, and a sub image stream included in the GOP to output the video frame to the video decoder 404 and the audio frame to the audio decoder 406. The sub image stream is stored in the image memory 407 and navigation button information is stored in the dynamic scenario memory 412. The multiple separation processing performed by the demultiplexer 403 includes transformation processing for transforming a TS packet to a packetized elementary stream (PES) packet.

The video decoder 404 decodes the video frame outputted from the demultiplexer 403 and writes an uncompressed picture in the video plane 405.

The video plane 405 is a memory for storing an uncompressed picture.

The audio decoder 406 decodes the audio frame outputted from the demultiplexer 403 and outputs uncompressed audio data.

The image memory 407 is a buffer which stores: the sub image stream read from the demultiplexer 403; the portable network graphics (PNG) data in the navigation button information; or an image file read from the BD-ROM, the removable medium 104, or the local storage 422 via the virtual file system 423.

The image plane 408 is a memory having a region for one screen. The sub image stream, the PNG data, or the image file which has been deployed is placed on the image plane 408.

The image decoder 409 deploys, and writes on the image plane 408, the sub image stream, the PNG data, the image file, or the like stored in the image memory 407. Various menus and a sub image appear on the screen by decoding the sub image stream.

The adder 410 combines, and outputs, the uncompressed picture data stored in the video plane 405 and the images deployed on the image plane 408. For example, the screen image in which the CG (an image of the owl in the diagram) moves about next to the screen on which video is displayed is obtained by combining the image in the image plane 408 and the picture in the video plane 405 by the adder 410.

The static scenario memory 411 is a memory for storing a current playlist or current stream management information. The current playlist (also abbreviated as current PL) is a playlist that is currently a target for processing, among playlists recorded on the BD-ROM, the local storage 422, or the removable medium 104. The current stream management information is currently a target for processing, among plural items of stream management information recorded on the BD-ROM, the local storage 422, or the removable medium 104.

The dynamic scenario memory 412 is a memory in which the current dynamic scenario is stored for processing performed by the HDMV module 413 and the BD-J module 414. The current dynamic scenario is a scenario that is currently a target for execution, among plural scenarios recorded on the BD-ROM, the local storage 422, or the removable medium 104.

The HDMV module 413 is a DVD virtual player that is a main body of execution in the HDMV mode, and executes a current scenario program read into the dynamic scenario memory 412.

The BD-J module 414 is a Java platform and includes: a Java virtual machine, a configuration, and a profile. The BD-J module 414 generates and executes a current Java object using a Java class file read into the dynamic scenario memory 412. The Java virtual machine transforms the Java object described in the Java language into a native code of a central processing unit (CPU) in the reproduction device and causes the CPU to execute the Java object.

The UO detection module 415 detects a user operation on a remote controller or a front panel (an operation panel such as a touch-pad) of the reproduction device, and outputs information (hereinafter referred to as UO) that indicates the user operation, to the mode management module 416.

The mode management module 416 holds a mode management table read from the BD-ROM, the local storage 422, or the removable medium 104 to perform mode management and branch control. The mode management performed by the mode management module 416 includes: assigning one of the HDMV module 413 and the BD-J module 414 to execute the dynamic scenario; reproduction instruction to the assigned module, and monitoring reproduction state in the assigned module. Monitoring reproduction state allows, at the time of transition to another title, such as when reproduction of a title in the HDMV module 413 or the BD-J module 414 ends, selecting a title to be reproduced next, assigning a module suitable for the selected title, and issuing a reproduction instruction to the assigned module, thereby enabling reproduction to continue.

In addition, the mode management module 416 may acquire the content of the register 424 from the AV reproduction library 420 while a title is reproduced, and store all or part of the content into the nonvolatile memory 425 together with other information which can be acquired by the mode management module 416. In addition, when issuing a reproduction instruction to the assigned module in the mode management, the instruction may be issued together with the content acquired from the nonvolatile memory 425 to start reproduction in a state different from a normal initial state. In addition, an instruction for generating data may be issued to the virtual file system 423. This will be described in detail later.

The dispatcher 417 selects a UO suitable to the current mode in the reproduction device from among the UOs, and sends the selected UO to the module that executes the mode. When a UO such as up, down, left and right commands or activation is received while the HDMV mode is executed, for example, the dispatcher 417 outputs the UO to the module of the HDMV mode.

The rendering engine 418 includes an infrastructure software such as a Java 2D and an OPEN-GL, draws computer graphics according to an instruction from the BD-J module 414, and outputs the drawn computer graphics to the image plane 408.

The AV reproduction library 420 executes an AV reproduction function or a playlist reproduction function in response to a function call from the HDMV module 413 or the BD-J module 414. The AV reproduction function is a functional group following DVD players and CD players, and is a function for carrying out processing such as starting reproduction, stop reproduction, suspending reproduction, cancelling of suspending reproduction, cancelling of a still image function, fast-forwarding with reproduction speed specified at an immediate value, rewinding with reproduction speed specified at an immediate value, switching of audio, switching of sub images, and switching of angle. The playlist reproduction function is a function for carrying out the starting reproduction and the stop reproduction, among the AV reproduction functions, according to the playlist information.

In addition, the AV reproduction library 420 includes the register 424. The register 424 includes a region in which the to reproduction state of a playlist, given information used by the content, and so on can be stored. The reproduction state of a playlist indicates a state such as which AV data is used among various AV data information items described in the playlist, and which position (time) in the playlist is reproduced. When the reproduction state of a playlist changes, the AV reproduction library 420 stores, into the register 424, the content such as the reproduction state of the playlist. In addition, the AV reproduction library 420, in response to an instruction from the content executed by the HDMV module 413 or the BD-J module 414, stores a value specified by the content, or send the stored value to the content.

The network interface 421 is an interface for communication with outside the reproduction device, and accesses to a server that can be accessed via the Internet or to a server connected through a local network. The network interface 421, for example, is used for downloading BD-ROM additional content published on the Internet, or enables reproduction of content utilizing the network function by performing data communication with a server on the Internet specified by the content. The BD-ROM additional content is content not included in an original BD-ROM, and includes for example: additional sub audio, caption, special feature images, an application, and so on. It is possible to control the network interface 421 by the BD-J module 414, and to download, into the local storage 422 or the removable medium 104, the additional content published on the Internet.

The local storage 422 and the removable medium 104 are used for storing additional content that has been downloaded, data used by an application and the like, and so on. The region for storing additional content is separate for each BD-ROM, and the region that can be used by an application for holding data is separate for each application. In addition, merge management information in which a merging rule indicating how to merge the downloaded additional content with data on the BD-ROM is also stored in the local storage 422 or the removable medium 104.

The virtual file system 423 establishes a virtual BD-ROM (a virtual package) obtained by merging the additional content stored in the local storage 422 or the removable medium 104 with the content on the BD-ROM, based on the merge management information downloaded into the local storage 422 or the removable medium 104 together with the additional content. The HDMV module 413 or the BD-J module 414 can refer to the virtual package and the original BD-ROM without distinction. The reproduction device 101 controls reproduction using not only the data on the BD-ROM but also data in the local storage 422, the removable medium 104, and the storage unit 426, during reproduction of the virtual package.

The nonvolatile memory 425 is a readable and writable recording medium capable of holding recorded content even when power is not supplied. An example is, for example, a flash memory, a ferroelectric random access memory (FeRAM), and the like. In addition, the removable medium 104, the local storage 422, or a recording medium which is writable by the BD-ROM drive 401 may be used as the nonvolatile memory 425. In addition, a medium that can be accessed via the network interface 421 may be used as the nonvolatile memory 425 as long as the recorded content can be held irrespective of power supply status of the reproduction device 101.

The storage unit 426 is a recording medium that can record given data. The virtual file system 423 can store specific data into the storage unit 426 in response to an instruction from the mode management module 416.

The components described above are related to the normal reproduction, the resume processing, and the simple resume processing performed by the reproduction device 101. It is to be noted that the functional configuration described above is an example of the reproduction device of the BD-ROM, and the present invention can also be implemented with other functional configuration as long as an operation described later can be embodied.

The reproduction unit 301 shown in FIG. 5 corresponds to the HDMV module 413, the BD-J module 414, the mode management module 416, the AV reproduction library 420, the virtual file system 423, and the like in FIG. 6. The reproduction information storage unit 302 corresponds to the mode management module 416. The nonvolatile memory 303 corresponds to the nonvolatile memory 425. The reproduction information acquiring unit 304 corresponds to the mode management module 416. The data generating unit 305 corresponds to the virtual file system 423. The determination unit 306 corresponds to the mode management module 416. It is to be noted that the function of the determination unit 306 may be executed by another processing unit that is not shown in FIG. 6. This applies to other processing units as well.

The following describes processing of storing reproduction information carried out by the simple resume reproduction device according to the present embodiment. The processing of storing reproduction information is carried out while the content is reproduced or when the reproduction is interrupted.

The reproduction information includes a reproduction position and a title number of a digital stream. In addition, the content of the register 424 may be included. The content of the register 424 is, for example, a stream number that is information indicating which an image, audio, and a caption are reproduced among plural images, audio, and captions included in the digital stream. In addition to the above, the information indicates whether or not each of the images, audio, and captions are output. In addition, the reproduction position and the title number of the digital stream may be held by the register 424. Hereinafter, the reproduction position and the title number of the digital stream is held in the register 424 in the following description, however, the present embodiment can be implemented with any manner of holding, even when the reproduction position and the title number of the digital stream are not held in the register 424, as long as they can be acquired by the mode management module 416.

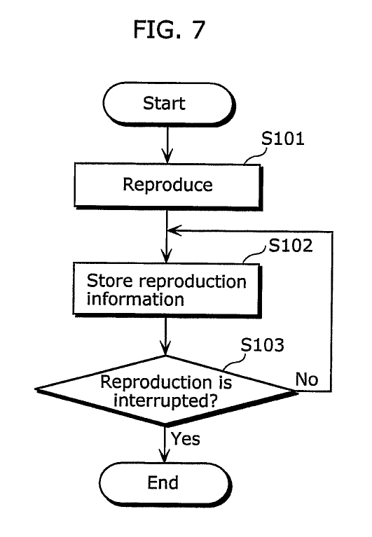

FIG. 7 is a flow chart which shows an operation of processing of storing reproduction information performed by the reproduction device according to the present embodiment. FIG. 7 shows the case where the processing of storing reproduction information is performed while content is reproduced.

First, the reproduction unit 301 reproduces content (S101). It is to be noted that the content may be reproduced in any one of the normal reproduction, the resume reproduction, and the simple resume reproduction.

The reproduction information storage unit 302 stores is reproduction information into the nonvolatile memory 303 with a predetermined timing while the content is reproduced (S102). More specifically, the mode management module 416 acquires the reproduction information with a predetermined timing from the register 424 and causes the nonvolatile memory 425 to hold the acquired reproduction information.

Then the processing of storing the reproduction information is repeated until the reproduction of the content is interrupted (S103).

In addition, when the reproduction information is stored in the nonvolatile memory 425, plural regions for holding the reproduction information may be prepared in the nonvolatile memory 425 to always keep holding the reproduction information that is stored previously, in order to avoid partially missing the reproduction information due to shutting off of power supply or unanticipated malfunction, thereby reducing the risk of missing reproduction information. It is to be noted that other known techniques may be used for the method of avoiding missing the reproduction information and implementation of the present invention is not affected by what method of avoidance is taken, and thus the detailed explanation will be omitted.

In addition, processing of storing reproduction information may also be carried out while the simple resume reproduction is performed, as described above. In that case, information may be added which indicates that reproduction performed at the time of acquiring the reproduction information was simple resume reproduction, as a part of the reproduction information.

Furthermore, when reproduction of content is interrupted based on an instruction from a user or the like, reproduction information may be stored in the nonvolatile memory when interrupting the reproduction.

The following describes the resume reproduction using reproduction information held in the nonvolatile memory.

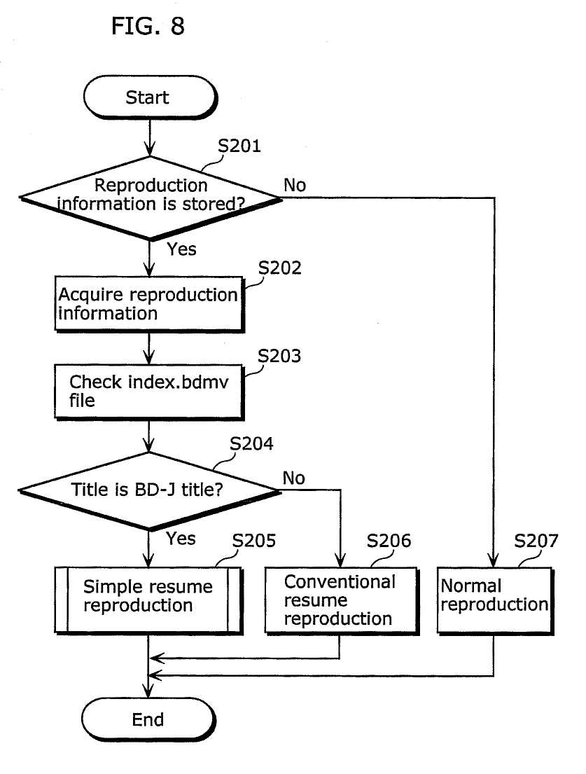

FIG. 8 is a flow chart which shows an operation of resume reproduction performed by the reproduction device according to the present embodiment.

First, the determination unit 360 determines whether or not the simple resume reproduction device 300 (the reproduction device 101) can perform the resume reproduction (S201). As an example here, the determination unit 306 determines whether or not reproduction information is held in the nonvolatile memory 303 (the nonvolatile memory 425). When reproduction information is held in the nonvolatile memory 425, the reproduction device 101 can perform the resume reproduction.

When it is determined that the reproduction device 101 can perform the resume reproduction (Yes in S201), the reproduction information acquiring unit 304 (the mode management module 416) acquires reproduction information from the nonvolatile memory 303 (the nonvolatile memory 425) (S202). More specifically, the mode management module 416 acquires reproduction information from the nonvolatile memory 425 when starting reproduction in response to power activation or disc insertion.

Next, the reproduction information acquiring unit 304 (the mode management module 416) checks the index.bdmv 201 based on the acquired reproduction information (S203). More specifically, the mode management module 416 acquires a title number using the acquired reproduction information and refers to the mode management table that is the content of the index.bdmv 201, thereby identifies the mode in which the title should be reproduced. The method of acquiring the mode management table is as stated above. In addition, the mode management table does not necessarily need to be referred to when the mode can be identified. Information related to the mode may be included in the reproduction information, for example.

When the title is found to be the BD-J title as a result of checking the index.bdmv 201 by the reproduction information acquiring unit 304 (Yes in S204), the reproduction unit 301 performs the simple resume reproduction (S205). More specifically, the mode management module 416 transmits, to the virtual file system 423, information related to the title number and a digital stream, among items of reproduction information. Here, the information related to a digital stream is an identifier for the PLAYLIST, for example, and information for specifying a digital stream to be reproduced.

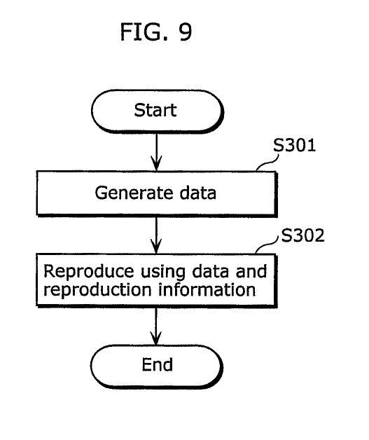

FIG. 9 is a flow chart which shows an operation of simple resume reproduction performed by the reproduction device according to the present embodiment.

The data generating unit 305 (the virtual file system 423) generates data based on the acquired reproduction information (S301). More specifically, the virtual file system 423 receives information related to the title number and the digital stream from the mode management module 416. Then the virtual file system 423 generates data based on the received information and stores the generated data to the storage unit 426. Here, the data that is generated is, to be specific, a file for replacing the file on the BD disc (a file such as the index.bdmv 201) shown in FIG. 2, and has content based on the configuration same as the file to be replaced.

Next, the reproduction unit 301 performs resume reproduction using the acquired reproduction information and the generated data (S302). Details of the resume reproduction will be described later with reference to various information and data in diagrams.

When the title is found to be the HDMV title as a result of checking the index.bdmv 201 by the reproduction information acquiring unit 304 (No in S204), the reproduction unit 301 performs conventional resume reproduction (S206). More specifically, the mode management module 416 issues, to the HDMV module 413, a reproduction instruction together with the reproduction information. The HDMV module 413 extracts, from the received reproduction information, content to be held by the register 424, stores the extracted content to the register 424, and then starts reproduction based on the reproduction information.

When it is determined that the reproduction device 101 cannot perform resume reproduction (No in S201), the reproduction unit 301 performs not the resume reproduction but the normal reproduction. More specifically, reproduction is started not from the stop position but from the beginning, a position specified by a user, or the like (S207).

As described above, the simple resume reproduction device according to the present embodiment can change the mode of an image to be reproducible (the HDMV mode, for example) irrespective of the mode at the time of interruption of reproduction, and can reproduce the image from a reproduction position in the changed mode. With this, even when the mode at the time of interruption of reproduction is the BD-J mode, it is possible to perform the resume reproduction by changing the mode into the HDMV mode. This has not been attained with the conventional techniques.

With this, only a single image (images and audio of a movie or the like) is displayed on the display 103 subsequent to resumption of reproduction after interruption as shown in FIG. 4A, whereas two images (images and audio of a movie or the like, and an image for menu display (an owl)) are displayed on the display 103 before interruption as shown in FIG. 4B.

It is to be noted that, descriptions for the specific method of starting reproduction of images and audio from a middle of reproduction, especially a decoding method and a cashing method for a digital stream, are omitted because they are known techniques, however, the present invention can be implemented with any method.

In addition, reproduction information does not necessarily need to be acquired when resuming reproduction, and whether or not to acquire may be determined according to arbitrary determination. When reproduction information is not acquired or cannot be acquired from the nonvolatile memory 425, a normal reproduction may be performed, and the present invention can be implemented by performing any other processing.

It is to be noted that the arbitrary determination is, for example, acquiring reproduction information only when the reason for the previous interruption is shut off of power supply.

In addition, when information of the recording medium included in the reproduction information is different from information included in the recording medium to be reproduced or when the reproduction information is partially corrupted, the mode management module 416 can also start the normal reproduction without using the reproduction information even when the reproduction information can be acquired is from the nonvolatile memory 425.

Next, the simple resume reproduction according to the present embodiment will be described in detail below with reference to information and data described above.

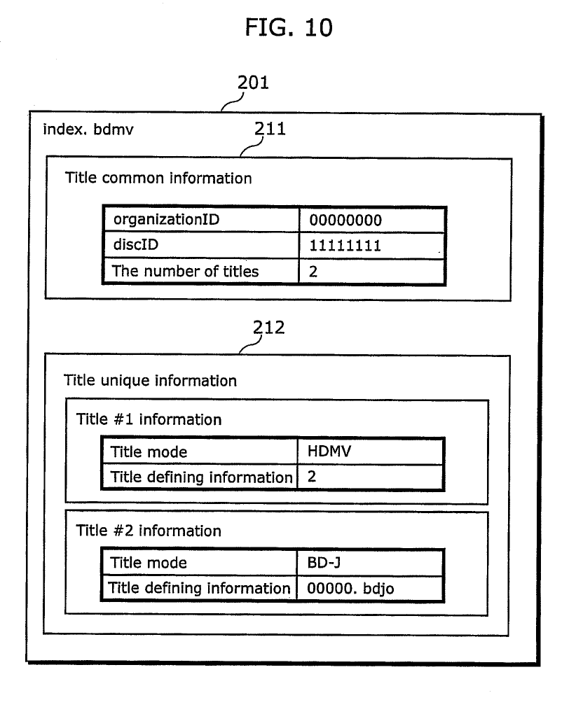

FIG. 10 is a diagram which schematically shows an example of content of the index.bdmv 201 that is one of the files on the BD disc shown in FIG. 2. As shown in the diagram, the index.bdmv 201 includes title common information 211 and title unique information 212.

The title common information 211 shows an example of the case where an organization ID is “00000000”, a disc ID is “11111111”, and the total number of titles is two.

The title unique information 212 includes information related to each of the titles. The title included in the title unique information 212 is reproduction control information. Here, the title common information 211 indicates that the content includes two titles, that is, a title #1 and a title #2. The title unique information 212 indicates that the title mode of the title #1 is the HDMV and the title defining information of the title #1 is defined in the second place of the MovieObject.bdmv. In addition, the title unique information 212 indicates that the title mode of the title #2 is the BD-J and the title defining information of the title #2 is 00000.bdjo that is present in the bdjo directory.

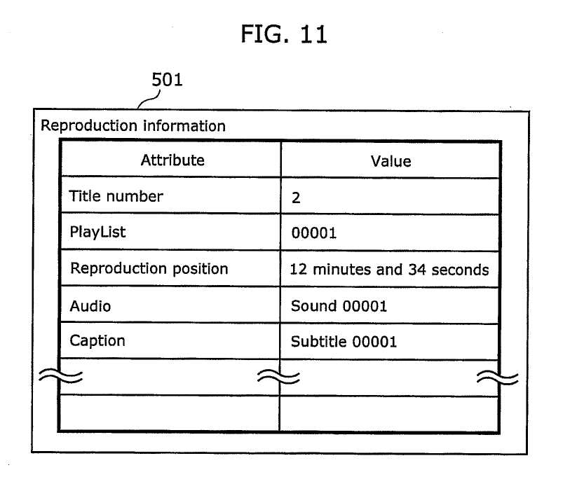

FIG. 11 is a diagram which schematically shows an example of content of the reproduction information acquired by the mode management module 416. The reproduction information 501 in the diagram indicates that the title number is “2”, the identifier of the PLAYLIST is “00001”, the reproduction position is “12 minutes and 34 seconds”, the identifier of the audio is “sound00001”, and the identifier of the caption is “subtitle00001”. This means that, while the “PLAYLIST 00001” of the title number “2” is reproduced, the mode management module 416 stores the reproduction information into the nonvolatile memory 425 at the reproduction position of “12 minutes and 34 seconds”. It is further indicated that the audio is “sound00001” and the caption is the “subtitle00001”.

In addition, it can be determined that the title is to be reproduced in the BD-J mode, based on the fact that the title number is “2” and the content of the index.bdmv 201 shown in FIG. 10.

The following describes the case where the mode management module 416 transmits, to the virtual file system 423, the title number (“2” in this case) and information related to the digital stream (“00001” in this case), based on the reproduction information shown in FIG. 11.

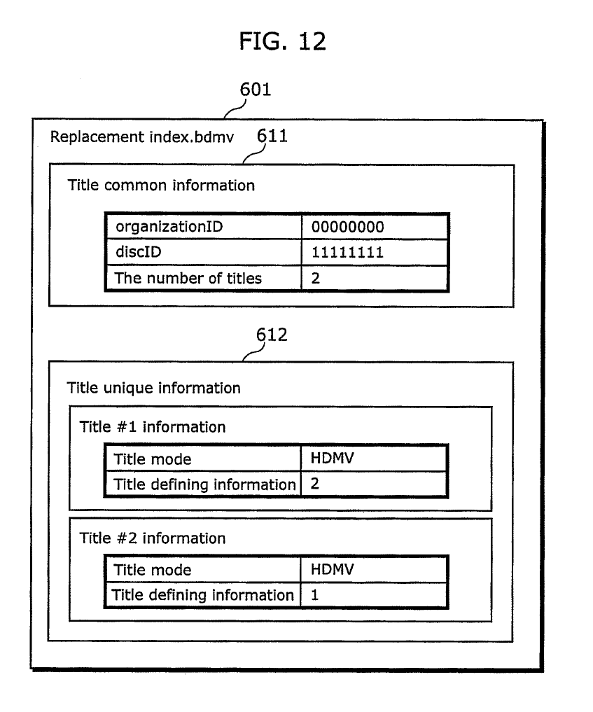

FIG. 12 is an example of data generated by the virtual file system 423 in order to replace the index.bdmv 201 on the BD disc. The replacement index.bdmv 601 in the diagram has the same configuration as that of the index.bdmv 201, however, the content is different. More specifically, the replacement index.bdmv 601 includes the title common information 611 and the title unique information 612 in the same manner as the index.bdmv 201.

The title common information 611 corresponds to the title common information 211. Here, the title common information 611 has the same content as that of the title common information 211, however, the content does not need to be the same and may be different.

The title unique information 612 corresponds to the title unique information 212. Here, the content includes two titles of a title #1 and a title #2. The title unique information 612 indicates that the title mode of the title #1 is the HDMV and the title defining information of the title #1 is defined in the second place of the MovieObject.bdmv. In addition, the title unique information 612 indicates that the title mode of the title #2 is the HDMV and the title defining information of the title #2 is defined in the first place of the MovieObject.bdmv.

Here, the replacement index.bdmv 601 is data generated based on the reproduction information transmitted to the virtual file system 423 from the mode management module 416. Thus, since “2” is transmitted as a title number, to be specific, the information of the title #2 in the title unique information 612 is changed from the information of the title #2 in the title unique information 212 of the index.bdmv 201.

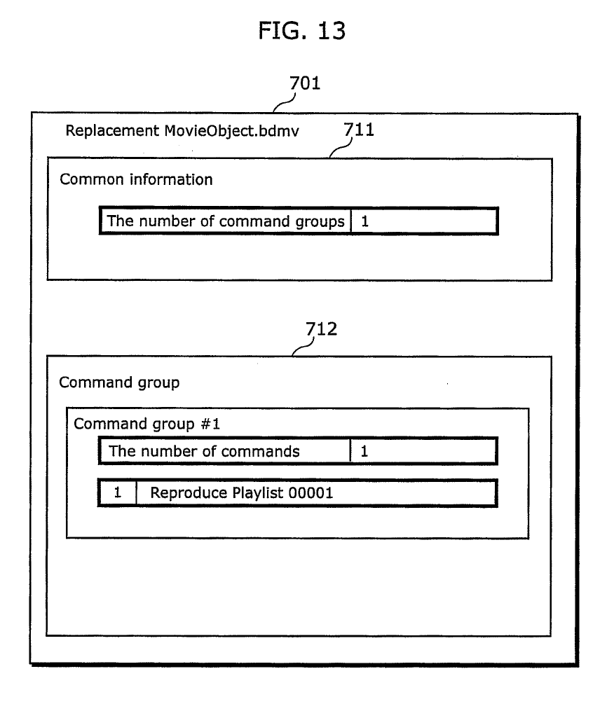

FIG. 13 is a diagram which shows an example of data generated by the virtual file system 423 in order to replace the MovieObject.bdmv 202 on the BD disc. The replacement MovieObject.bdmv 701 in the diagram includes common information 711 and a command group 712.

The number of command groups included in the command group 712 is described in the common information 711. It is indicated here that the number of command groups is one.

Command groups of the number of command groups indicated in the common information 711 are described in the command group 712. Here, the number of commands indicating the total number of commands included therein and as many commands as the number of commands are placed in the command group #1. Here, the number of command is one and the first command indicates “reproduce PLAYLIST 00001”. It is to be noted that, any kind and number of commands may exist in implementing the present embodiment, as long as a target PLAYLIST can be reproduced.

The replacement MovieObject.bdmv 701 is generated irrespective of the MovieObject.bdmv 202. The replacement MovieObject.bdmv 701 701 is generated based on the reproduction information transmitted to the virtual file system 423 from the mode management module 416. More specifically, since “00001” is transmitted as information related to the digital stream, the PLAYLIST used for the first command of the command group #1 indicates the same “00001”.

The following describes a more specific operation of the simple resume reproduction according to the present embodiment, taking the case where data indicated in FIG. 12 and FIG. 13 is generated, as a representative example for the present embodiment.

The virtual file system 423, after the aforementioned data generation is carried out, when receiving a request for reading the “index.bdmv” file and the “MovieObject.bdmv” file from outside, returns not a file on the BD disc but generated data items respectively corresponding to the files, as a result of reading the files.

The mode management module 416 transmits the reproduction information to the virtual file system 423. The virtual file system 423 generates data according to the transmitted reproduction information, and then the mode management module 416 tries to reproduce the title corresponding to the title number included in the reproduction information.

The virtual file system 423 reads, as the mode management information, the replacement index.bdmv 601 generated by the virtual file system 423, in the same manner as the normal mode management. Then, mode management is carried out based on the content of the replacement index.bdmv 601 that has been read. More specifically, the virtual file system 423 carries out mode management based on the replacement index.bdmv 601 that has been generated, whereas, in general, mode management is carried out based on the index.bdmv 201 indicated in FIG. 10.

As the example described above, when the title #2 described in the reproduction information is reproduced, the mode management module 416 determines that the title #2 is the BD-J mode when data on the BD disc is used as it is, whereas the mode management module 416 determines that the title #2 is the HDMV mode because the title #2 is changed to the HDMV mode as shown in the title unique information 612 of FIG. 12. Then, the mode management module 416 issues, to the HDMV module 413, a reproduction instruction together with the reproduction information. The HDMV module 413 extracts, from the received reproduction information, content to be held by the register 424 and stores the extracted content to the register 424, and then starts reproduction based on the reproduction information.

The HDMV module 413, in the same manner as in the normal reproduction, acquires, from the index.bdmv, title defining information corresponding to the title number indicated by the instruction, acquires a command group to be executed, from the MovieObject.bdmv, based on a command group number described as the title defining information, and then executes commands of the command group in sequence from the top. However, since the content of the index.bdmv is replaced here by the virtual file system 423 as described above, the title defining information corresponding to the title #2 in this case, that is, the command group number, becomes one. In addition, since the MovieObject.bdmv is also replaced by the virtual file system 423, the content of the command group #1 in this case indicates that the number of commands is one and the first command is “reproduce PLAYLIST 00001”. Thus, since the HDMV module 413 executes “reproduce PLAYLIST 00001”, “PLAYLIST 00001” is reproduced. In addition, unlike the normal reproduction, since the HDMV module 413 performs reproduction based on the reproduction information transmitted by the mode management module 416, reproduction is started from the reproduction position (the position at “12 minutes and 34 seconds” in the case of FIG. 11) included in the reproduction information.

As described above, with the simple resume reproduction device according to the present embodiment, it is possible to resume reproduction of an image and audio, in the HDMV mode, at the position where reproduction is interrupted or in the vicinity of the position, even when the reproduction is interrupted due to shutting off of power supply or the like while the image and audio are reproduced in the BD-J mode.

It is to be noted that, description has been presented with reference to FIG. 10 to FIG. 13 as examples for each information and data in the present embodiment, however, the present embodiment can be implemented even when the content of each information and data is different, as long as the index.bdmv and the MovieObject.bdmv can be replaced according to reproduction information and reproduced in the same manner as in resume reproduction in the HDMV mode.

### Embodiment 2

In Embodiment 1, content that has been reproduced in the BD-J mode is reproduced in the HDMV mode, thereby performing the resume reproduction of the BD-J title. On the other hand, the present embodiment describes a method of performing the resume reproduction by changing the content included in the BD-J title without changing the mode.

The present embodiment differs from Embodiment 1 in the is processing after the mode management module 416 determines that the title should be reproduced in the BD-J mode and reproduction using reproduction information is to be performed. Other processing is the same as that in Embodiment 1, and thus descriptions for that is omitted. In addition, the same numerals are assigned to the same elements as in Embodiment 1 and the description that is overlapped will be omitted.

When the mode management module 416 determines that the title should be reproduced in the BD-J mode and reproduction using reproduction information is to be performed, the mode management zs module 416 acquires title defining information corresponding to the title from a mode management table. The simple resume reproduction device according to the present embodiment is described taking, as a representative example, the case where the index.bdmv 201 indicates the content shown in FIG. 10 and the reproduction information 501 acquired by the mode management module 416 from the nonvolatile memory 425 indicates the content shown in FIG. 11, in the same manner as in Embodiment 1.

The mode management module 416 finds, from a title number “2” included in the reproduction information, that related title defining information is “00000”. This may be found by referring to the mode management table, or may be included in the reproduction information in advance.

Next, the mode management module 416 transmits the title defining information “00000” to the virtual file system 423, and the virtual file system 423 generates data based on the title defining information and stores the generated data into the storage unit 426.

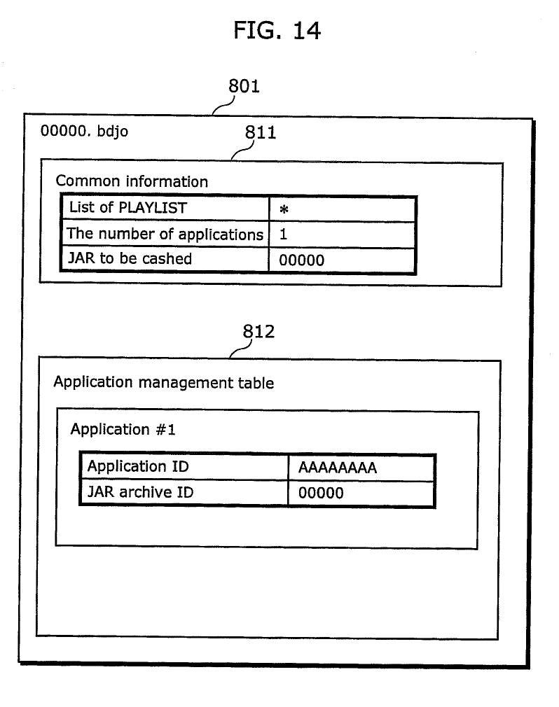

FIG. 14 is a diagram which schematically shows an example of data generated by the virtual file system 423 according to Embodiment 2 More specifically, FIG. 14 shows an example of data generated by the virtual file system 423 for replacing a file (“00000.bdjo”) which has an extension bdjo contained in the BDJO directory on the BD disc and has “00000” transmitted by the virtual file system 423 as an identifier.

Common information 811 and an application management table 812 are included in the 00000.bdjo 801.

The common information 811 includes an identification information list of PLAYLIST used for a corresponding title, the number of applications, and an identification information list of JAR to be cashed. In the identification information list of PLAYLIST, “*” indicating that all PLAYLIST is the target of use can be specified, and the “*” is specified in the example shown in FIG. 14. In addition, it is indicated that the number of applications is one and the identifier of JAR to be cashed is “00000”.

The application management table 812 includes: an application ID that is an identifier for an application indicated by the common information 811; and a JAR archive ID that is an identifier for a JAR archive file that belongs to the application. In the example shown in FIG. 14, the application ID is “AAAAAAAA” and the JAR archive ID is “00000”.

In addition, the virtual file system 423 generates a JAR file for replacing a JAR file (“00000.jar”) which has the identifier (“00000”) of the JAR to be cashed described in the 00000.bdjo 801. It is to be noted that, when the BD disc does not include “00000.jar” file, a JAR file is not replaced but added.

The JAR file generated by the virtual file system 423 includes therein a Java application that can be executed by the reproduction device. This Java application has a function for carrying out resume reproduction. More specifically, reproduction of an image and audio can be resumed at a reproduction position, a menu can be displayed, chapter jumping can be performed, and switching of audio and a caption can be controlled. The Java application included in the generated JAR file is directed to the resume reproduction, and thus it is possible to make the Java application in consideration of reducing activation time.

It is to be noted that, for the Java application, any measures can be used for acquiring the identifier and a reproduction stop position of the PLAYLIST of which reproduction should be resumed. For example, information related to the reproduction may be dynamically generated as a data file, and the generated information may be stored in the JAR file or in a place available to the Java application through the virtual file system 423. Thus, the generated information may be placed in any place where the BD-J module 414 can use the information.

In addition, when the Java application is dynamically generated, the generated information may be incorporated in the Java application. Furthermore, information may be embedded in a database file (00000.bdjo, for example).

In addition, similarly to Embodiment 1 in which the HDMV module 413 resumes reproduction of an image and audio at the reproduction position in response to an instruction from the mode management module 416, the BD-J module 414 may resume reproduction of an image and audio at a reproduction position. More specifically, when the BD-J title has an automatic reproduction function for an image and audio before the Java application is activated, an image and audio to be reproduced may be selected based on the identifier of PLAYLIST included in the reproduction information as a target of automatic reproduction, and the position of starting reproduction may be determined using information on the reproduction position included in the reproduction information.

In addition, the JAR file may be dynamically generated by the virtual file system 423 or the JAR file prepared in advance may be used. Furthermore, the JAR file acquired from outside the reproduction device via the network interface 421 based on the identification information on the BD disc may be used. The present invention can be implemented by preparing the JAR file in any measures.

As described above, in the simple resume reproduction device according to the present embodiment, the data generating unit 305 in FIG. 5 generates data including an application different from an application recorded on the recording medium 105 and reproduction control information that controls execution of the application.

Then, the reproduction unit 301 executes the application controlled by the reproduction control information included in the data generated by the data generating unit 305, thereby reproducing content from the reproduction position.

With this, the simple resume reproduction device according to the present embodiment can reproduce content from the reproduction position by generating a JAR file or the like that enables reproducing the content in the BD-J mode, based on the reproduction information at the time of interruption of reproduction, whereas resume reproduction cannot be performed conventionally because the JAR file recorded on the BD-ROM or the like is used.

Thus, with the simple resume reproduction device according to the present embodiment, it is possible to resume reproduction of an image and audio, in the BD-J mode, at the position where reproduction is interrupted or in the vicinity of the position, even when reproduction is interrupted due to shutting off of power supply or the like during reproducing the image and audio in the BD-J mode. In other words, the resume reproduction can be carried out.

It is to be noted that the mode management module 416 transmits the title defining information “00000” to the virtual file system 423 and the virtual file system 423 generates data based on the transmitted title defining information and stores the generated data in the storage unit 426, however, the title defining information in the index.bdmv may be fixed to a predetermined value (“00000”, for example) in the same manner as in Embodiment 1.

With this, the present embodiment can be implemented without transmitting the title defining information “00000” to the virtual file system 423 by the mode management module 416. In this case, the title number needs to be transmitted for replacing the index.bdmv in the same manner as in Embodiment 1.

### Embodiment 3

In Embodiment 1, the mode management module 416 transmits, to the virtual file system 423, the title number and information related to a digital stream among items of reproduction information. However, since the size of index.bdmv to be replaced increases as the title number included in the reproduction information has a larger value, generating data and reading the generated data are time consuming in some cases.

It is to be noted that, in the present embodiment, the same numerals are assigned to the same elements as in Embodiment 1 and the description that is overlapped will be omitted.

The simple resume reproduction device according to the present embodiment does not use the title number included in the reproduction information, and transmits, to the virtual file system 423, only the information related to a digital stream.

The virtual file system 423, when receiving the information related to a digital stream from the mode management module 416, generates data based on the information and stores the generated data in the storage unit 426. In addition, the virtual file system 423 generates given data in advance for replacing the index.bdmv 201 on the BD disc. The data generated in advance is held in the nonvolatile memory 425, for example.

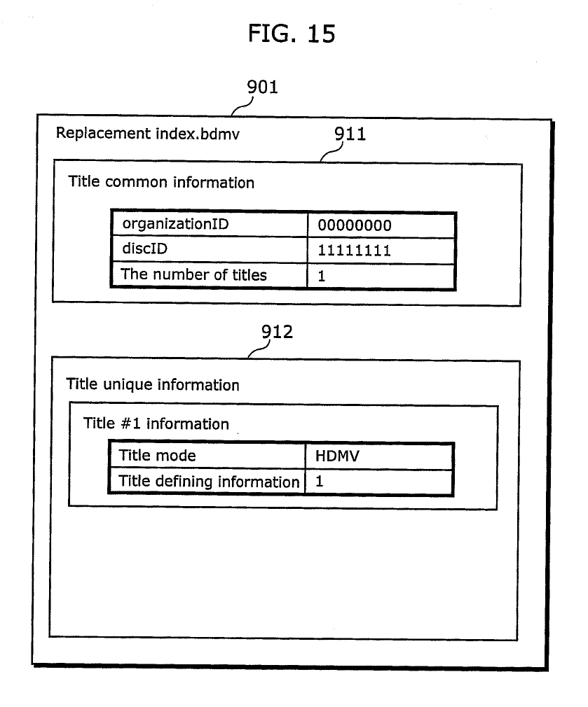

FIG. 15 is a diagram which shows an example of data prepared in advance by the virtual file system 423 in order to replace the index.bdmv 201 on the BD disc. The replacement index.bdmv 901 in the diagram has the same configuration as the index.bdmv 201, however, the content is different. More specifically, the replacement index.bdmv 901 includes the title common information 911 and the title unique information 912 in the same manner as the index.bdmv 201.

The title common information 911 corresponds to the title common information 211. The title common information 911 here indicates that the number of titles is one, unlike the title common information 211. This indicates that, in the replacement index.bdmv 901, the number of titles is one irrespective of the reproduction information transmitted from the mode management module 416.

The title unique information 912 corresponds to the title unique information 212. Here, it is indicated that the content includes one title, the title mode of the title #1 is the HDMV, and the title defining information of the title #1 is defined in the first place of the MovieObject.bdmv. It is to be noted that the example shown here indicates that the number of titles is one and the title defining information is 1, however, the present embodiment can be embodied when the content is fixed, not depending on the reproduction information transmitted from the mode management module 416.

Furthermore, the virtual file system 423 generates a replacement MovieObject.bdmv in order to replace the MovieObject.bdmv in the same manner as in Embodiment 1. The generated MovieObject.bdmv is the same as the one shown in FIG. 13 in Embodiment 1, and thus description will be omitted.

The mode management module 416 transmits the reproduction information to the virtual file system 423. The virtual file system 423 generates data according to the transmitted reproduction information, and then the mode management module 416 tries to reproduce a title corresponding to the predetermined title number without using the title number included in the reproduction information. Here, the predetermined title number is determined as data prepared by the virtual file system 423 in advance, and determined as “1” in the example of FIG. 15.

More specifically, when replacing the index.bdmv 201 with the replacement index.bdmv 901 shown in FIG. 15, reproduction of the title number “1” is tried even when “2” is included as the title number in the reproduction information. The mode management module 416 issues, to the HDMV module 413, a reproduction instruction together with the reproduction information. The subsequent processing is the same as that in Embodiment 1, and thus descriptions for that is omitted.

As described above, the simple resume reproduction device according to the present embodiment performs the resume reproduction, using not the title number indicated in the reproduction information but the predetermined title number. More specifically, the data generating unit 305 in FIG. 5 generates data for specifying a title in advance and stores the generated data in the nonvolatile memory 303. The reproduction unit 301 performs the resume reproduction, using the title specified from the data stored in the nonvolatile memory 303.

This eliminates the necessity of dynamically generating the index.bdmv, and thus it is possible to reduce the content of the index.bdmv compared to the content of the index.bdmv in Embodiment 1. Thus, it is possible to reduce a memory region for holding the generated data and processing amount related to data generation, and thus it is possible to start faster resume reproduction.

### Embodiment 4

The simple resume reproduction is performed by changing an original reproduction mode of content that exists in a BD disc in Embodiments 1, 2, and 3, however, changing a reproduction mode can cause problems as below. In the present embodiment, the method for solving the problems will be described.

One of the problems is that, when an image and audio reach an end during the simple resume reproduction, the next processing cannot be carried out and the image and audio stop, for example.

When the image and audio reach an end and the reproduction in complete after the simple resume reproduction is started, what processing should be carried out next is described normally in advance as data on the BD disc. When the reproduction device can interpret the content of processing to be performed next, it is only necessary to include information that fits to the content, into the data after replacement. However, when the content of processing cannot be interpreted, the reproduction device, usually, cannot determine what processing should be performed next.

Thus, the present embodiment describes the case where the mode management module 416, when the reproduction of an image and audio reaches an end, determines the processing to be performed next and performs the determined processing.

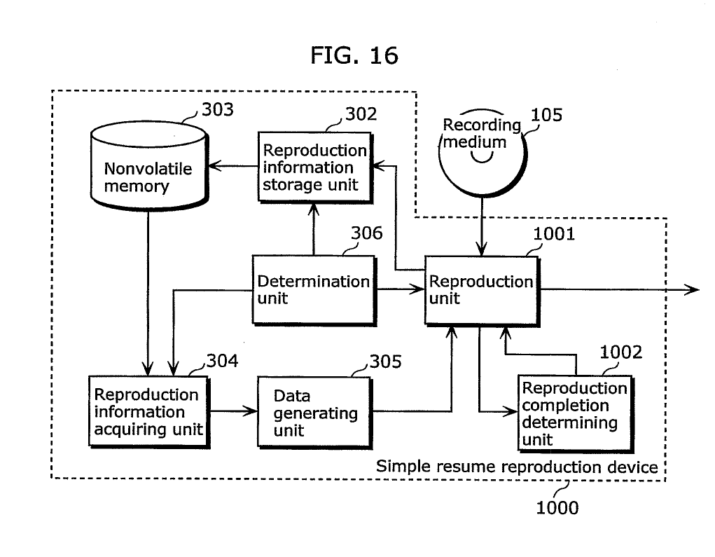

FIG. 16 is a block diagram which shows a configuration of a simple resume reproduction device according to the present embodiment. The simple resume reproduction device 1000 in the diagram is different from the simple resume reproduction device 300 in FIG. 5 in that a reproduction unit 1001 is included instead of the reproduction unit 301 and a reproduction completion determining unit 1002 is newly included. In the description below, the same numerals are assigned to the same elements, the description that is overlapped will be omitted, and the descriptions will focus on the differences.

The reproduction unit 1001 performs the normal reproduction, the resume reproduction, the simple resume reproduction, and so on, in the same manner as in the reproduction unit 301. In addition, the reproduction unit 1001 determines the processing to be performed next, based on a result of determination notified by the reproduction completion determining unit 1002 and executes the determined processing. The processing to be performed next is, for example, reproduction of an image and audio which have been reproduced in the simple resume reproduction, from the beginning in the normal reproduction. The reproduction unit 1001 corresponds to the mode management module 416, the HDMV module 413, the BD-J module 414, the AV reproduction library 420, and the like.

The reproduction completion determining unit 1002 determines whether or not the image and audio that are being reproduced reach an end when the reproduction unit 1001 performs the simple resume reproduction. The result of determination is notified to the reproduction unit 1001. The reproduction completion determining unit 1002 corresponds to, for example, the HDMV module 413, the BD-J module 414, or the like.

The following describes more detailed processing, using the elements shown in FIG. 6.

In the case where the simple resume reproduction is performed in the HDMV mode, the HDMV module 413 notifies, when the reproduction of the image and audio reaches an end, the mode management module 416 accordingly. In the case where the simple resume reproduction is performed in the BD-J mode, the BD-J module 414 notifies, when the reproduction of the image and audio reaches an end, the mode management module 416 accordingly. It is to be noted that this can be performed in the same manner as in the processing of the case where normal reproduction of the HDMV title or the BD-J title ends.

The mode management module 416, when it is notified that the reproduction reaches an end, performs reproduction, as one method of implementation, from the top of the image and audio which is reproduced in the simple resume reproduction, that is, from a position of reproduction time 0 in the PLAYLIST which is reproduced in the simple resume reproduction. This makes it possible to prevent reproduction from being stopped.

In addition, as another method of implementation, it is also possible to proceed with reproduction according to the procedure for reproducing a BD medium when the BD medium such as a BD disc is inserted, by bringing the state of the reproduction device 101 back to the one when the BD media is inserted. In this case, it is necessary, before proceeding with the reproduction, for the mode management module 416 to issue an instruction to the virtual file system 423 and restore the data on the BD medium which is replaced and reproduced by the virtual file system 423. More specifically, it is possible to perform reproduction using the data on the BD medium, by using not the data generated by the virtual file system 423 but the data on the BD medium as it is.

As described above, with the simple resume reproduction device according to the present embodiment, even when an image and audio reproduced in the simple resume reproduction reach an end, it is possible to perform the next processing, thereby preventing interruption in the image and audio.

### Embodiment 5

The simple resume reproduction device and the simple resume reproduction method described in Embodiments 1 to 4 have a feature that a reproduction mode is different from that of the normal reproduction of a BD medium. In the simple resume reproduction device and the simple resume reproduction method described in Embodiments 1 to 4, the menu display, an operation when reaching an end, and the like differ from those in the normal reproduction. However, since the image and audio seem for a user to be reproduced as being not different from the normal reproduction, it is difficult to determine that the normal reproduction is performed or the simple resume reproduction according to the present invention is performed. Thus, the present embodiment describes a display method for allowing the simple resume reproduction according to an aspect of the present invention to be used by a user without misinterpretation or confusion.

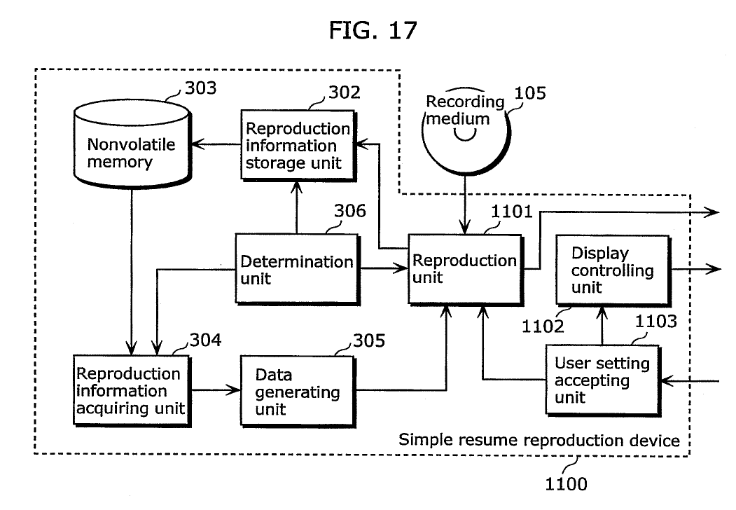

FIG. 17 is a block diagram which shows a configuration of a simple resume reproduction device according to the present embodiment. The simple resume reproduction device 1100 in the diagram includes a reproduction unit 1101, a display controlling unit 1102, and a user setting accepting unit 1103.

The reproduction unit 1101 performs the normal reproduction, the resume reproduction, the simple resume reproduction, and so on, in the same manner as in the reproduction unit 301. In addition, the reproduction unit 1101 reproduces content recorded on the recording medium 105 based on a user setting accepted by the user setting accepting unit 1103. More specifically, the reproduction unit 1101 switches between the normal reproduction and the simple resume reproduction based on the accepted instruction. The reproduction unit 1101 executes the simple resume reproduction when the accepted instruction indicates that the simple resume reproduction is to be performed. It is to be noted that the reproduction unit 1101 corresponds to the HDMV module 413, the BD-J module 414, the mode management module 416, the AV reproduction library 420, and the like.

The display controlling unit 1102 controls the content displayed by the display 103. More specifically, the display controlling unit 1102 controls the display of a graphical user interface (GUI) for accepting the setting by the user, the display of information indicating whether or not the image and audio that is reproduced is reproduced in the simple resume reproduction, and the like. When it is determined that the instruction accepted by the user setting accepting unit 1103 is not an executable instruction, for example, the display controlling unit 1102 controls the display of the information indicating that the instruction is not executable. It is to be noted that the display controlling unit 1102 may perform control for causing not an external display 103 but a display included in the simple resume reproduction device 1100 (not illustrated) to display. It is to be noted that the display controlling unit 1102 corresponds to the mode management module 416, the virtual file system 423, and the like.

The user setting accepting unit 1103 accepts a setting from a user and outputs the accepted setting to the reproduction unit 1101 and the display controlling unit 1102. The accepted setting is, for example, an instruction indicating whether or not the simple resume reproduction is carried out. Or, the accepted setting is an instruction indicating, when the simple resume reproduction is already performed, whether the normal reproduction is to be performed or the simple resume reproduction is to be continued.

In addition, the user setting accepting unit 1103 accepts other various instructions from the user. At this time, the user setting accepting unit 1103 determines whether or not the accepted instruction is executable. It is to be noted that the user setting accepting unit 1103 corresponds to the UO detection module 415.

The following describes the GUI, symbols, marks, and so on which are displayed on the display 103 according to various situations.

The case where the determination unit 306 determines whether or not to perform the simple resume reproduction is described in Embodiment 1, and preference and intention of a user are further added, as information for making determination, to the determination in the present embodiment. The preference and intention of a user are, for example, whether or not the user desires execution of the simple resume reproduction.

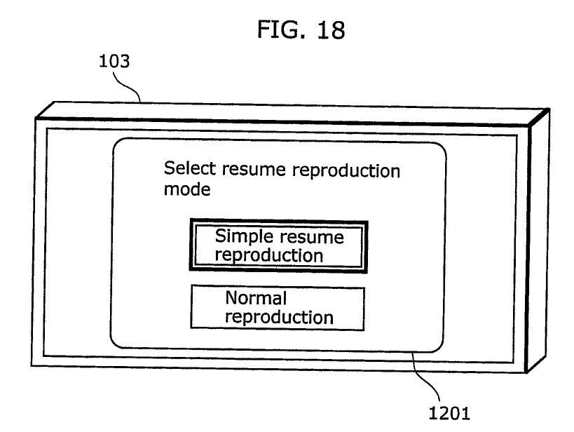

FIG. 18 is a diagram which shows an example of a displayed image of the display 103 according to the present embodiment. The display 103 shown in the diagram displays a GUI 1201 that urges a user to select between starting the simple resume reproduction and performing a normal reproduction of a BD medium. The user is allowed to transmit, to the mode management module 416 (the reproduction unit 1101) the preference of the user by selecting one of selection buttons on the GUI 1201 using the remote controller 102 to, for example.

With this, the user is allowed not only to confirm that the simple resume reproduction is started but also to select not starting the simple resume reproduction.

It is to be noted that, when the simple resume reproduction device 1100 recognizes in advance an item that the user desires to select, reproduction can be started in line with the intention of the user without presenting the display image shown in FIG. 18.

In addition, it is also difficult to discriminate between the simple resume reproduction and the normal reproduction after the simple resume reproduction is performed when the image and audio is just viewed, as described above. Thus, a symbol indicating that the simple resume reproduction is being performed is displayed on the screen during the simple resume reproduction.

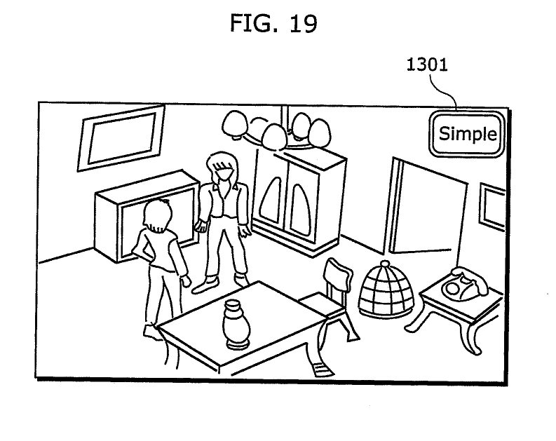

FIG. 19 is a diagram which shows an example of a displayed image of the display 103 according to the present embodiment. The display 103 shown in the diagram displays, on the screen, a symbol 1301 indicating that the currently reproduced image and audio is reproduced in the simple resume reproduction. The word “simple” is displayed on the upper-right corner of the screen here, however, any symbol or mark may be used as long as the user can differentiate them. In addition, a known technique for combining images may be used in order to avoid hindering of viewing of the images. Images may be rendered transparent by making the images translucent, for example.

In addition, when the simple resume reproduction device 1100 or the display 103 includes light source mounted thereon, it is possible to inform the user that the reproduction differs from the normal reproduction, by illuminating the light source, for example. That means that the display controlling unit 1102 may inform the user that the reproduction differs from a normal reproduction using other measures such as light source.

Similarly, as to the processing at the time of reaching an end as shown in Embodiment 4, it is possible to branch the processing by confirming with the user.

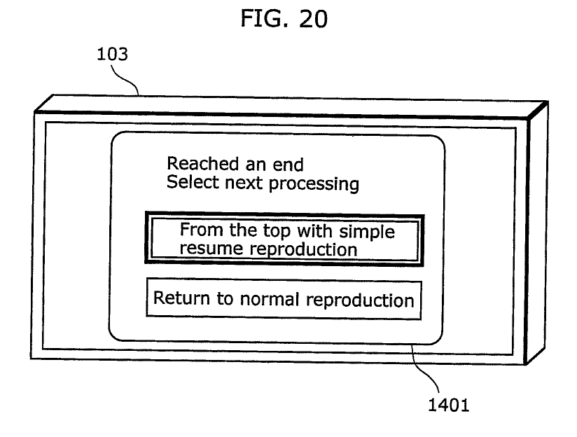

FIG. 20 is a diagram which shows an example of a displayed image of the display 103 according to the present embodiment. The display 103 shown in the diagram displays a GUI 1401 that informs a user of reaching an end and also urges the user to select the next processing. Here, the user can select between starting reproduction at the top of images and audio in the simple resume reproduction state and performing the normal reproduction of a BD medium. The result of the user selection is transmitted to the mode management module 416 (the reproduction unit 1101) and the mode management module 416 can determine the next operation according to the result.

In addition, the remote controller 102 which can be operated during the normal reproduction of the BD medium cannot be operated during the simple resume reproduction in some cases. In the case where a Java application on the BD medium acquires operation information of the remote controller 102 and carries out some processing such as changing the display, switching audio, and so on according to the operation information, for example, the processing (assumed changing of the display, switching of audio, and so on) is not carried out when the Java application is not active. This sometimes makes the user confused in operation. In order to solve the problem, when a predetermined operation of the remote controller 102 is carried out during the simple resume reproduction, a message indicating that the performance accompanied with the operation has brought an unintended outcome may be informed to the user.

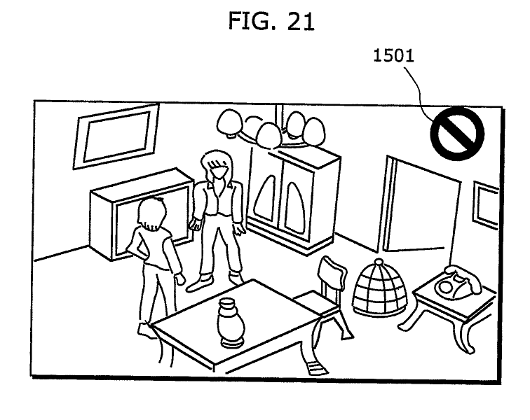

FIG. 21 is a diagram which shows an example of a displayed image of the display 103 according to the present embodiment. The display 103 shown in the diagram displays a symbol 1501 on the upper-right corner of the screen as a message indicating that a user operation cannot be executed.

In addition, in response to a user's intention, it is also possible to return to the normal reproduction of the BD medium during the simple resume reproduction. This is carried out, for example, by a predetermined operation using the remote controller 102, menu selection on the screen, and the like. Furthermore, in some cases, the simple resume reproduction cannot be continued due to some malfunction in reproduction and it becomes necessary to return to the normal reproduction of the BD medium.

When returning from the simple resume reproduction to the normal reproduction of the BD medium as described above, it is also possible to inform the user to that effect, as well as to urge the user to select between actually returning and not returning to the normal reproduction of the BD medium.

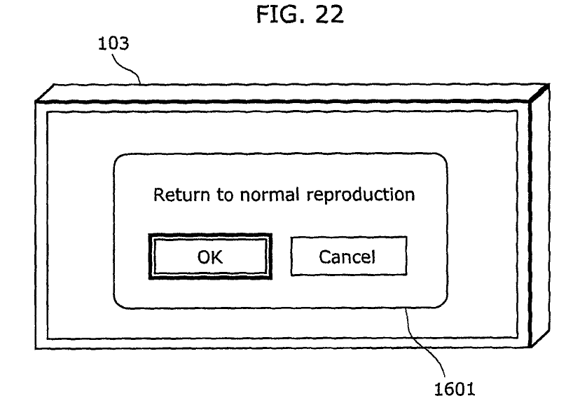

FIG. 22 is a diagram which shows an example of a displayed image of the display 103 according to the present embodiment. The display 103 shown in the diagram displays a GUI 1601 that informs a user that the reproduction is to return to the normal reproduction of the BD medium and urges the user to select between approval and disapproval. The mode management module 416 can determine whether to return to the normal reproduction of the BD medium or to continue the simple resume reproduction, according to the result of selection by the user using the remote controller 102.

In addition, in such a case where a reproduction position or the title number is changed in response to a jump operation by the user during the simple resume reproduction, it is possible to stop the simple resume reproduction and shift to the normal reproduction, by satisfying specified conditions. At this time, whether or not to shift to the normal reproduction may be confirmed by the user.

The specified conditions are specifically, when changing a reproduction position, based on a result of determination, for information related to the reproduction position after the change, using information of the length of the PLAYLIST, availability of the UO, and so on, as described above.

It is to be noted that, the display is mainly described as a measure to inform the user, however, the measure is not limited to the display and any measures such as sound or vibration may be used as long as it is possible to inform the user of a message.

As described above, the simple resume reproduction device according to the present embodiment displays, on the display, a GUI, a symbol, or the like according to various situations. In addition, settings of a user are accepted using the displayed GUI or the like.

With this, it is possible to easily sending and receiving instructions between the simple resume reproduction device and the user. In addition, since a reproduction situation can be informed to the user with a display indicating whether the images and audio are reproduced in the normal reproduction or in the simple resume reproduction, it is possible to inform the case where a user operation cannot be accepted, for example.

### Embodiment 6

The resume reproduction is implemented, in Embodiments 1 to 5, by changing the mode and replacing the Java application that is executed, in order to solve the problem that reconstructing an execution state of the Java application is difficult. On the other hand, in the present embodiment, the case is described where the title is recorded on the BD medium as the BD-J mode, but a Java application referred to from the title does not exist or is not executed.

Since the Java application is not executed in the simple resume reproduction device according to the present embodiment, it is not necessary to reconstruct the execution state. Thus, when it is possible to only restore a reproduction position of images and audio, the resume reproduction can be carried out even for a title that is reproduced in the BD-J mode.

In the present embodiment, the processing of acquiring reproduction information from the nonvolatile memory 425, determining that the mode in which the title is to be reproduced is the BD-J mode, and determining that reproduction is performed using the reproduction information, which is performed by the mode management module 416, is the same that of Embodiments 1 to 5, and thus the description will be omitted. It is to be noted that, the same numerals are assigned to the same elements as in Embodiment 1 and so on, and the description that is overlapped will be omitted.

The mode management module 416 determines that execution of the Java application is not necessary in reproduction of a title, by referring to title defining information on the BD medium or the content of existing data, for the title. At this time, unlike Embodiments 1 to 5, a reproduction instruction for the title is issued, to the BD-J module 414, together with the reproduction information, without issuing an instruction for replacing data to the virtual file system 423. The BD-J module 414, when the reproduction instruction for the title is received together with the reproduction information, reproduces images and audio according to an identifier of PLAYLIST and a reproduction position included in the reproduction information.

According to the present embodiment, data on the BD medium is not necessarily replaced in performing resume reproduction in the BD-J mode for a title that does not include a Java application or includes a Java application that is not executed, even when the title is operated in the BD-J mode.

It is to be noted that the mode management module 416, when reproduction information is stored in the nonvolatile memory 425, can include information indicating whether or not a Java application is operated, as a portion of the reproduction information. With this, it is possible to execute the operation described in the present embodiment without using information related to the title recorded on the BD medium, after the reproduction information is read from the nonvolatile memory 425.

It is to be noted that data used for reproduction using known reproduction method is collectively called as data on the BD medium in the present invention for simplification, however, the data on the BD medium does not necessarily represent only data actually existing in the BD medium, and the present invention can be implemented as long the data on the BD medium can be handled by the reproduction device as being virtually existing on the BD medium.

The simple resume reproduction device and the simple resume reproduction method have been described based on the embodiments; however, the present invention is not limited to these embodiments. Other forms in which various modifications apparent to those skilled in the art are applied to the embodiment, or forms structured by combining elements of different embodiments are included within the scope of the present invention, unless such changes and modifications depart from the scope of the present invention.

For example, the present invention may be implemented, in addition to implementation as the simple resume reproduction device and the simple resume reproduction method, as a program which, when loaded into a computer, allows a computer to execute the simple resume reproduction method according to the embodiments, as described above. In addition, the present invention may also be implemented as a non-transitory computer-readable recording medium such as a CD-ROM, which has the program recorded thereon. Furthermore, the present invention may also be implemented as information, data, or a signal which indicates the program. Furthermore, the program, the information, the data and the signal may be distributed via a communication medium such as the Internet.

Furthermore, some or all of the constituent elements of which the simple resume reproduction device is configured may be configured using a single system LSI (large scale integration) circuit, according to the present invention. The system LSI is a super-multi-function LSI manufactured by integrating constituent units on one chip, and is specifically a computer system configured by including a microprocessor, a ROM, a RAM, and so on.

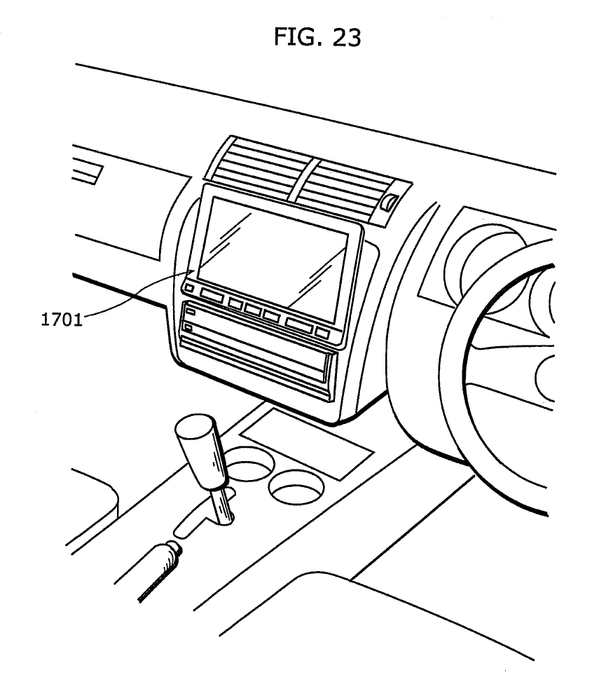

It is to be noted that the simple resume reproduction device according to the present invention is used for, for example, an on-vehicle digital television 1701 shown in FIG. 23.

In addition, the content of data generated by the virtual file system 423 is secured by the virtual file system 423, and thus it is possible to omit verification processing such as manipulation verification, data error verification, and the like.

In addition, the mode management module 416 acquires the content of the register 424 from the AV reproduction library 420 while a title is reproduced, and stores all or part of the content into the nonvolatile memory 425 together with other information which can be acquired by the mode management module 416, however, the content of the static scenario memory 411 may be included in the reproduction information. With this, it is possible to use the content of the static scenario memory 411 as an element of the conditions for starting resume.

For example it is also possible to use, among items of the content of the static scenario memory 411, the length of the PLAYLIST that is reproduced, that is, the length of time for reproducing images and audio. A condition that is “only when the length of the PLAYLIST is 10 minutes or longer” is added to the above-mentioned conditions for executing the resume reproduction, for example. The specific length may be any length for implementing the present invention. Further, the length does not have to be fixed, and can be changed according to the type of data existing on the BD medium, a preference of a user, or the like.

In addition, it is also possible to use availability information for the UO, among the items of the content of the static scenario memory 411. A condition that is “only the UO that does not forbid “fast forward”” is added, for example. The type of the current PLAYLIST can be analogized using the availability information for the UO, and thus it is possible to determine whether or not to perform resume reproduction.

In addition, it is possible to determine whether or not to perform the resume reproduction in the same manner, using information included in the index.bdmv 201. Two modes of the HDMV mode and the BD-J mode are described as examples in each of the embodiments, however, when information related to each mode is added or another mode is added, whether or not to perform the resume reproduction may be determined according to the type of the mode.

In addition, the determination may be carried out before the mode management module 416 stores the reproduction information into the nonvolatile memory 425 or after the mode management module 416 acquires the reproduction information from the nonvolatile memory 425.

In addition, it is also possible to include the result of change of the register 424 in the reproduction information as other information that can be acquired and to use the result of change as an item of the conditions for starting the resume reproduction. More specifically, all or part of the change of the register 424 is monitored and a condition that is “only when the target of monitor does not change” can be added. With this, it is also possible to identify the content that is not suitable for the target of the resume reproduction, based on a use status of the register 424, and on the contrary, to prevent performing the resume reproduction on the content that is not desired to be reproduced in the resume reproduction, using a register that is the target for monitoring.

In addition, it is also possible to include, in the reproduction information, as other information that can be acquired, whether or not a message for forbidding the resume reproduction is transmitted from the BD-J module 414 to the mode management module 416 and to use the information as an item of the conditions for starting the resume reproduction. With this, it is possible, when a Java application on the BD medium is executed, for example, to forbid the resume reproduction when the Java application executes a specified instruction. The specified instruction is, for example, an instruction related to the network, an instruction that is important in terms of security, a control instruction of the virtual file system, and so on. It is to be noted that the present invention can be implemented whichever instruction is used as a condition for forbidding the resume reproduction.

It is to be noted that, when it can be determined in advance, in the mode management module 416 before reproduction is interrupted due to shut off of power supply or the like, that reproduction information is not to be used after the next reproduction is started, the mode management module 416 does not have to store the reproduction information into the nonvolatile memory 425.

In addition, when the reproduction information is already stored in the nonvolatile memory 425, the reproduction information may be deleted from the nonvolatile memory 425. The reproduction information may be stored in the nonvolatile memory 425 after explicitly including, in the reproduction information, information that the reproduction information is not to be used after the next reproduction is started.

It is to be noted that the mode management module 416, even during the resume reproduction, may acquire reproduction information from the register 424 with a certain timing and cause the nonvolatile memory 425 to store the acquired reproduction information, as described above. On the contrary, it is also possible to prevent the nonvolatile memory 425 from storing reproduction information during the resume reproduction.

It is to be noted that, the case is described where the mode management module 416 acquires reproduction information from the nonvolatile memory 425 and issues an instruction for replacing data to the virtual file system 423 based on the content of the reproduction information, however, the mode management module 416 may issue, after reproduction information is acquired from the register 424, an instruction for replacing data to the virtual file system 423 in advance, when causing the nonvolatile memory 425 to store the acquired reproduction information.

In addition, an instruction for using data generated earlier by the virtual file system 423 may be issued to the virtual file system 423, only when the instruction for generating the data is issued to the virtual file system 423 and the simple resume reproduction is determined to be performed. It is to be noted that it is also possible to cause the nonvolatile memory 425 to hold the data generated by the virtual file system 423.

In addition, the data generating unit 305 may generate data every time reproduction information is acquired, instead of generating data when resume reproduction is performed, and store the generated data into the nonvolatile memory 303. That means that the reproduction information acquiring unit 304, at this time, acquires reproduction information from the reproduction unit 301 and transmits the acquired reproduction information to the data generating unit 305. The data generating unit 305 generates data for enabling resume reproduction described in each of the embodiments, based on the transmitted reproduction information, and stores the data into the nonvolatile memory 303. Then, the reproduction unit 301 reproduces content by referring to the data stored in the nonvolatile memory 303, when performing resume reproduction.

Since this eliminates the necessity to generate data when performing resume reproduction, time taken for data generation can be reduced, and thus it is possible to start resume reproduction earlier.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The simple resume reproduction device according to the present invention can be used in the movie industry and the consumer product industry which are involved in creating image content, and can be used for, for example, a digital television, a BD player, a BD recorder, an on-vehicle digital television, and so on. Furthermore, the simple resume reproduction device according to the present invention can be manufactured and distributed economically, continuously, and iteratively, in the manufacturing industry.

What is claimed is:

1. A simple resume reproduction device which performs resume reproduction after reproduction of content recorded on a recording medium is interrupted,
wherein, the following are recorded on the recording medium:
the content;
a first application that is a program for reproducing the content; and
at least one first reproduction control information item for controlling execution of the first application,
said simple resume reproduction device comprising:
a reproduction unit configured to reproduce the content by executing the first application controlled according to the at least one first reproduction control information item; and
a reproduction information acquiring unit configured to acquire reproduction information indicating a reproduction position of the content,
wherein said reproduction unit is further configured to perform simple resume reproduction without executing the first application when performing the resume reproduction, the simple resume reproduction being processing in which the content is reproduced from the reproduction position indicated by the reproduction information acquired by said reproduction information acquiring unit.

2. The simple resume reproduction device according to claim 1, further comprising
a data generating unit configured to generate first data for enabling reproduction from the reproduction position indicated by the reproduction information, based on the reproduction information acquired by said reproduction information acquiring unit,
wherein said reproduction unit is configured to perform, when performing the resume reproduction, the simple resume reproduction by referring to the first data generated by said data generating unit.

3. The simple resume reproduction device according to claim 2, further comprising:
a nonvolatile storage unit; and
a reproduction information storage unit configured to store, in said nonvolatile storage unit, the reproduction information indicating the reproduction position at which the content is being reproduced or the reproduction of the content is interrupted,
wherein said reproduction information acquiring unit is configured to acquire, when performing the resume reproduction, the reproduction information stored in said nonvolatile storage unit, and
said data generating unit is configured to generate the first data when performing the resume reproduction.

4. The simple resume reproduction device according to claim 3, further comprising
a determination unit configured to determine whether or not to perform the simple resume reproduction,
wherein said reproduction unit is configured to perform, when performing the resume reproduction, the simple resume reproduction only when said determination unit determines that the simple resume reproduction is to be performed.

5. The simple resume reproduction device according to claim 4,
wherein said reproduction information storage unit is configured to store the reproduction information into said nonvolatile storage unit only when said determination unit determines that the simple resume reproduction is to be performed, and
said reproduction unit is configured to perform the simple resume reproduction only when the reproduction information is stored in said nonvolatile storage unit.

6. The simple resume reproduction device according to claim 3,
wherein said data generating unit is configured to generate the first data including second reproduction control information of a type different from a type of the at least one first reproduction control information item, and
said reproduction unit is configured to reproduce the content from the reproduction position, as the simple resume reproduction, the content being referred to from the second reproduction control information included in the first data generated by said data generating unit.

7. The simple resume reproduction device according to claim 6,
wherein said data generating unit is configured to generate, as the first data, data including a command for reproducing the content from the reproduction position, the content being referred to from the second reproduction control information, and
said reproduction unit is configured to reproduce the content according to the command from the reproduction position, as the simple resume reproduction, the content being referred to from the second reproduction control information included in the first data.

8. The simple resume reproduction device according to claim 7,
wherein said data generating unit is further configured to generate second data in advance, the second data specifying the second reproduction control information,
said nonvolatile storage unit is configured to store the second data, and
said data generating unit is configured to generate, as the first data, data including a command for reproducing the content from the reproduction position, based on the reproduction information acquired by said reproduction information acquiring unit, the content being referred to from the second reproduction control information specified by the second data.

9. The simple resume reproduction device according to claim 3,
wherein said data generating unit is configured to generate the first data including second reproduction control information that controls execution of a second application different from the first application controlled by the at least one first reproduction control information item, and
said reproduction unit is configured to reproduce the content from the reproduction position, as the simple resume reproduction, by executing the second application controlled by the second reproduction control information included in the first data generated by said data generating unit.

10. The simple resume reproduction device according to claim 2, further comprising
a nonvolatile storage unit,
wherein said data generating unit is further configured to store the generated first data into said nonvolatile storage unit, and
said reproduction unit is configured to reproduce the content from the reproduction position, as the simple resume reproduction, by referring to the first data stored in said nonvolatile storage unit.

11. The simple resume reproduction device according to claim 2, further comprising
an accepting unit configured to accept an instruction from a user,
wherein said reproduction unit is configured to reproduce the content based on the instruction accepted by said accepting unit.

12. The simple resume reproduction device according to claim 11,
wherein said accepting unit is configured to accept the instruction indicating whether or not to perform the simple resume reproduction, and
said reproduction unit is configured to execute the simple resume reproduction when the instruction accepted by said accepting unit indicates that the simple resume reproduction is to be performed.

13. The simple resume reproduction device according to claim 11,
wherein said accepting unit is configured to accept, during the simple resume reproduction, the instruction indicating whether normal reproduction different from the resume reproduction is to be performed or the simple resume reproduction is to be continued, and
said reproduction unit is configured to perform the normal reproduction or the simple resume reproduction, based on the instruction accepted by said accepting unit.

14. The simple resume reproduction device according to claim 11, further comprising:
an instruction executability determining unit configured to determine whether or not the instruction accepted by said accepting unit is executable; and
an informing unit configured to inform the user that the instruction is not executable when said instruction executability determining unit determines that the instruction is not executable.

15. The simple resume reproduction device according to claim 2, further comprising
an informing unit configured to inform the user that the reproduction performed by said reproduction unit is the simple resume reproduction or normal reproduction.

16. The simple resume reproduction device according to claim 2, further comprising
a reproduction completion determining unit configured to determine whether or not the simple resume reproduction is complete,
wherein said reproduction unit is configured to reproduce predetermined content when said reproduction completion determining unit determines that the simple resume reproduction is complete.

17. The simple resume reproduction device according to claim 2,
wherein said reproduction information acquiring unit is configured to acquire, as the reproduction information, reproduction information in compliance with a BD-ROM standard.

18. A simple resume reproduction device which performs resume reproduction after reproduction of content recorded on a recording medium is interrupted,
wherein, the following are recorded on the recording medium:
the content;
an application that is a program for reproducing the content;
at least one reproduction control information item for controlling execution of the application, and
the content includes a first image and a second image that is reproduced only by executing the application,
said simple resume reproduction device comprising:
a reproduction unit configured to reproduce the content by executing the application controlled according to the at least one reproduction control information item; and
is a display unit configured to display the first and second image included in the content reproduced by said reproduction unit,
wherein said display unit is configured to display only the first image when resuming reproduction after reproduction of the content is interrupted.

19. A simple resume reproduction method for performing resume reproduction after reproduction of content recorded on a recording medium is interrupted,
wherein, the following are recorded on the recording medium:
the content,
an application that is a program for reproducing the content, and
at least one reproduction control information item for controlling execution of the application,
said simple resume reproduction method comprising:
reproducing the content by executing the application controlled according to the at least one reproduction control information item;
acquiring reproduction information indicating a reproduction position of the content, and
reproducing the content without executing the application when performing the resume reproduction, the content being reproduced from the reproduction position indicated by the reproduction information acquired in said acquiring.

20. A program product stored in a non-transitory computer-readable recording medium, which, when loaded into a computer, allows the computer to execute a simple resume reproduction method for performing resume reproduction after reproduction of content recorded on a recording medium is to interrupted,
wherein, the following are recorded on the recording medium:
the content,
an application that is a program for reproducing the content, and
at least one reproduction control information item for controlling execution of the application,
said simple resume reproduction method including:
reproducing the content by executing the application controlled according to the at least one reproduction control information item;
acquiring reproduction information indicating a reproduction position of the content, and
reproducing the content without executing the application when performing the resume reproduction, the content being reproduced from the reproduction position indicated by the reproduction information acquired in said acquiring.
